(19) United States
(12) Patent Application Publication
(10) Pub. No.: US 2013/0085428 A1
(43) Pub. Date: Apr. 4, 2013

(54) COMPRESSION ASSEMBLY

(71) Applicant: Manish Deshpande, Canton, MA (US)

(72) Inventor: Manish Deshpande, Canton, MA (US)

(73) Assignee: TYCO HEALTHCARE GROUP LP, Mansfield, MA (US)

(21) Appl. No.: 13/249,338

(22) Filed: Sep. 30, 2011

(51) Int. Cl. A61H 7/00

(52) U.S. Cl. 601/148

(57) ABSTRACT

A compression assembly is adapted for placement on a body part for imparting compression therapy to the body part. The compression assembly includes a bladder and a bladder support. The bladder support and bladder have corresponding connection structure for mounting the bladder on the bladder support. In certain embodiments, the bladder is held in tension when mounted on the bladder support. In certain embodiments, the bladder support includes protrusions adapted for push-in reception in openings on the bladder for mounting the bladder on the bladder support, the bladder support is adjustable in length, and the bladder is foldable for adjusting the length of the bladder. Removable mounting of the bladder on the bladder support enables selective disposal of the bladders and bladder supports and interchangeability of different types of bladders with particular bladder supports.

### FIELD OF THE INVENTION

The present invention generally relates to a compression assembly, and more particularly to a compression assembly including a bladder and a bladder support.

### BACKGROUND OF THE INVENTION

A major concern for generally immobile patients and like persons are medical conditions that form clots in the blood such as deep vein thrombosis (DVT) and peripheral edema. Such patients and persons include those undergoing surgery, anesthesia, and extended periods of bed rest. These blood clotting conditions generally occur in the deep veins of the lower extremities and/or pelvis. Veins such as the iliac, femoral, popliteal, and tibial veins return deoxygenated blood to the heart. When blood circulation in these veins is retarded due to, for example, illness, injury, or inactivity, there is a tendency for blood to accumulate or pool. A static pool of blood may lead to the formation of a blood clot, which can interfere with cardiovascular circulation. Most seriously, a fragment of the blood clot can break loose and migrate. A pulmonary embolus can form from the fragment potentially blocking a main pulmonary artery, which may be life threatening. The current invention can be applied to treat and prevent these and other conditions such as lymphedema.

Conventional vascular compression systems include a compression garment fluidly connected to a controller for cyclically inflating the compression garment. The cyclical inflation of the compression garment enhances blood circulation and decreases the likelihood of DVT. A system of conduits connects the compression garment to the controller. Some vascular compression garments have portable controllers that are much smaller and even mountable on the compression garment so that the patient may move about freely without having to first remove the compression garment or disconnect the compression garment from the controller. These compression garments may be worn when a patient is stationary or ambulatory and enhance patient compliance because of convenience of use.

### SUMMARY OF THE INVENTION

One aspect of the present invention is directed to a compression assembly adapted for placement on a body part for imparting compression therapy on the body part. The compression assembly includes a bladder having a length and a width, front and rear surfaces, a peripheral edge margin, an inflatable chamber, and a port providing fluid communication with the inflatable chamber. The bladder has connection structure located generally about the peripheral edge margin of the bladder. The compression assembly also includes a bladder support including a support surface and an opposite rear surface. The support surface is adapted for engaging the rear surface of the bladder. The bladder support has a length, a width, a peripheral edge margin including a peripheral edge, and a fastening assembly for securing the bladder support in a self-retaining configuration about the body part in which the bladder is disposed at least partially between the support surface and the body part. The bladder support is more rigid than the bladder. The bladder support has connection structure located generally about the peripheral edge margin of the bladder support for mounting the bladder on the bladder support. The connection structure of the bladder support is adapted for releasable engagement with the connection structure of the bladder support. The connection structures of the bladder and bladder support are arranged so that the bladder is held in tension when mounted on the bladder support.

Another aspect of the present invention is directed to a bladder for use with a bladder support in forming a compression assembly adapted for placement on a body part for imparting compression therapy on the body part. The bladder support includes connection structure for mounting the bladder on the bladder support. The bladder includes a body having a length and a width, front and rear surfaces, a peripheral edge margin, an inflatable chamber, and a port providing fluid communication with the inflatable chamber. The body has connection structure adapted for engaging the connection structure of the bladder support for positioning the bladder in a mounted position on the bladder support. At least a portion of the body is resiliently elastic which maintains the connection structure of the bladder in engagement with the connection structure of the bladder support when the bladder is in the mounted position on the bladder support.

Another aspect of the present invention is directed to a bladder support for use with a bladder for forming a compression assembly adapted for placement on a body part for imparting compression therapy on the body part. The bladder has a port providing fluid communication with an inflatable chamber on the bladder and has connection structure for mounting the bladder on the bladder support. The bladder support includes a fastening assembly for securing the bladder support in a self-retaining configuration about the body part. The bladder support also includes a body having a support surface and an opposite rear surface. The support surface is adapted for engaging the bladder when the bladder support is in the self-retaining position. The body has a peripheral edge margin including a peripheral edge. The body has connection structure adapted for engaging the connection structure of the bladder for positioning the bladder in a mounted position on the bladder support. The connection structure of the body is arranged for and the body has rigidity sufficient for tensioning the bladder when the bladder is in said mounted position on the bladder support.

Another aspect of the present invention is directed to a compression assembly adapted for placement on a body part for imparting compression therapy on the body part. The compression assembly includes a bladder having a length and a width, front and rear surfaces, a peripheral edge margin, an inflatable chamber, and a port providing fluid communication with the inflatable chamber. The bladder has one of openings and rigid or semi-rigid protrusions located generally about the peripheral edge margin of the bladder. The assembly also includes a bladder support including a support surface and an opposite rear surface. The support surface is adapted for engaging the rear surface of the bladder. The bladder support has a length, a width, a peripheral edge margin including a peripheral edge, and a fastening assembly for securing the bladder support in a self-retaining configuration about the body part in which the bladder is disposed at least partially between the support surface and the body part. The bladder support has the other of the openings and the protrusions located generally about the peripheral edge margin of the bladder support. The openings and protrusions are sized and shaped for releasable push-in reception of the protrusions in the openings, and reception of the protrusions in the openings releasably mounts the bladder on the bladder support.

Another aspect of the present invention is directed to a kit for forming first and second compression assemblies having different lengths and being adapted for placement on a body part for imparting compression therapy on the body part. The kit includes first and second bladders each having an inflatable chamber, a port providing fluid communication with the inflatable chamber permitting inflation of the inflatable chamber, and connection structure. The bladders each have a width and a length. The length of the first bladder is less than the length of the second bladder. The kit also includes a bladder support having a fastening assembly for securing the bladder support in a self-retaining configuration on the body part. The bladder support has a support surface adapted for engaging the first and second bladders when the bladder support is in the self-retaining position. The bladder support includes connection structure adapted for selectively engaging the connection structure of one of the first and second bladders for securely mounting the first and second bladders in a position for applying compression therapy to the body part. The bladder support includes a base and an extension. The extension is selectively movable with respect to the base for adjusting a length of the support surface for conforming to the length of the first bladder for forming said first compression assembly with the first bladder, and the extension is selectively movable with respect to the base for adjusting the length of the support surface for conforming to the length of the second bladder for forming said second compression assembly with the second bladder. The first compression assembly has a length which is shorter than a length of the second compression assembly.

Another aspect of the present invention is directed to a configurable bladder capable of being re-sized for mounting the bladder on a selected bladder support for placement on a body part for imparting compression therapy on the body pall. The bladder support has connection structure for mounting the bladder on the bladder support. The bladder includes a body including walls defining an inflatable chamber. A port through one of the walls provides fluid communication with the inflatable chamber permitting inflation of the inflatable chamber. The body has a first end, a second end opposite the first end, and a peripheral edge margin including a peripheral edge. The body includes connection structure associated with at least one of the walls adapted for connecting to the connection structure of the bladder support for mounting the bladder on the bladder support. The body has a first configuration in which the connection structure of the body is positioned for engaging the connection structure of the bladder support for securely mounting the body on the bladder support. The body has a second configuration in which the walls are folded to decrease the size of the body and the connection structure of the body is positioned for engaging the connection structure of the bladder support for securely mounting the body on the bladder support.

Other objects and features will be in part apparent and in part pointed out hereinafter.

### BRIEF DESCRIPTION OF THE DRAWINGS

FIG. 1 is a perspective of a compression assembly of the present invention including a bladder and a bladder support shown in a self retaining configuration on a leg;

FIG. 2 is a front elevation of the compression assembly of FIG. 1;

FIG. 3 is a front elevation of the bladder support;

FIG. 4 is a rear elevation of the bladder;

FIG. 5 is a section of the compression assembly taken in the plane including line 5-5 in FIG. 2;

FIG. 6 is a front elevation of a second embodiment of a bladder support;

FIG. 7 is a section similar to that shown in FIG. 5 but including the bladder support of FIG. 6;

FIG. 8 is a fragmentary perspective of a third embodiment of a bladder support;

FIG. 9 is a fragmentary perspective of a fourth embodiment of a bladder support;

FIG. 10 is a fragmentary front elevation of a bladder associated with the bladder support of FIG. 9;

FIG. 11 is a fragmentary front elevation of another bladder associated with the bladder support of FIG. 9;

FIG. 12 is a front elevation of another embodiment of a compression assembly of the present invention including a bladder and a bladder support; and

FIG. 13 is an exploded fragmentary rear perspective of the bladder support and bladder of FIG. 12;

FIG. 14 is a front elevation of another embodiment of a bladder support of the present invention;

FIG. 15 is a rear elevation of the bladder support of FIG. 14 showing the bladder support in a fully retracted configuration;

FIG. 16 is a front elevation of a compression assembly of the present invention including the bladder support of FIG. 14;

FIG. 17 is a rear elevation of the bladder support shown in an intermediate extended position;

FIG. 18 is a front elevation of a compression assembly of the present invention including the bladder support of FIG. 17 in the intermediate extended position;

FIG. 19 is a rear elevation of the bladder support shown in a fully extended position;

FIG. 20 is a front elevation of another embodiment of a bladder of the present invention, the bladder being adjustable in length by folding the bladder;

FIG. 21 is a front elevation of another embodiment of a bladder support of the present invention;

FIG. 22 is a front elevation of the bladder of FIG. 20 in a folded configuration and mounted on the bladder support of FIG. 21;

FIG. 22A is a front elevation of the bladder of FIG. 20 in a second folded configuration;

FIG. 23 is a front elevation of another embodiment of a bladder of the present invention, the bladder being adjustable in length by folding the bladder;

FIG. 24 is a front elevation of the bladder of FIG. 23 showing the bladder in a first folded configuration;

FIG. 25 is a front elevation of another embodiment of a compression assembly of the present invention including the bladder of FIG. 24;

FIG. 26 is a front elevation of the bladder of FIG. 23 shown in a second folded configuration;

FIG. 27 is a side elevation of yet another embodiment of a compression assembly of the present invention, the compression assembly being shown in a self-retaining configuration on a leg;

FIG. 28 is a front elevation of a bladder of the compression assembly of FIG. 27;

FIG. 29 is a front elevation of a bladder support of the compression assembly of FIG. 27;

FIG. 30A is a rear perspective of the compression assembly showing openings on the bladder positioned for push-in reception with protrusions on the bladder support;

FIG. 30B is a view similar to FIG. 30A but showing the openings received on the protrusions; and

FIG. 31 is a side elevation of yet another embodiment of a compression assembly of the present invention.

Corresponding reference characters indicate corresponding parts throughout the drawings.

### DETAILED DESCRIPTION

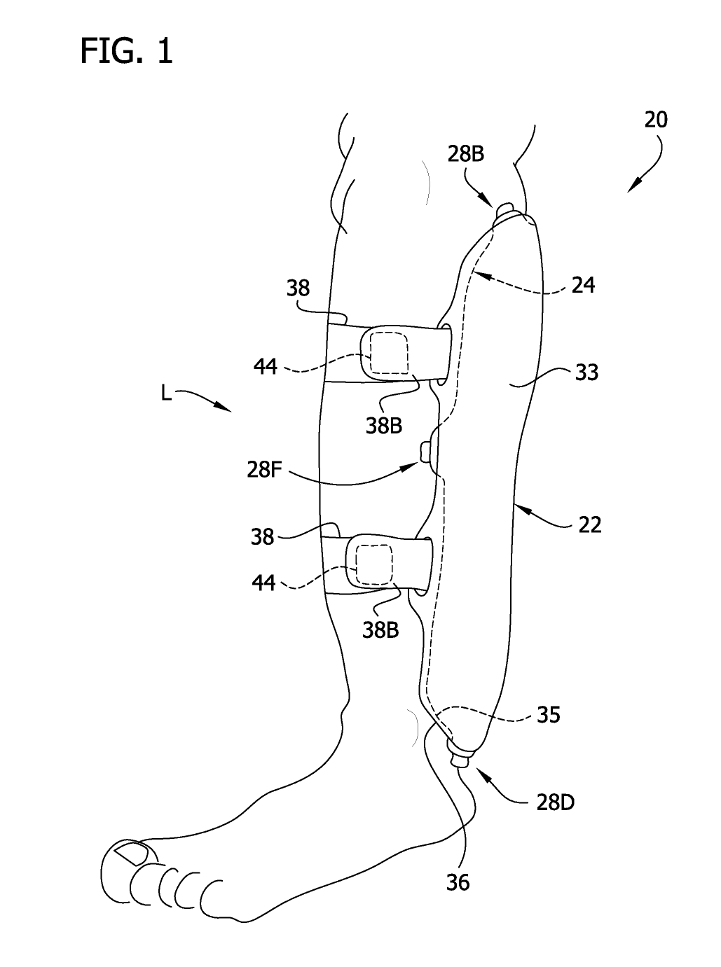

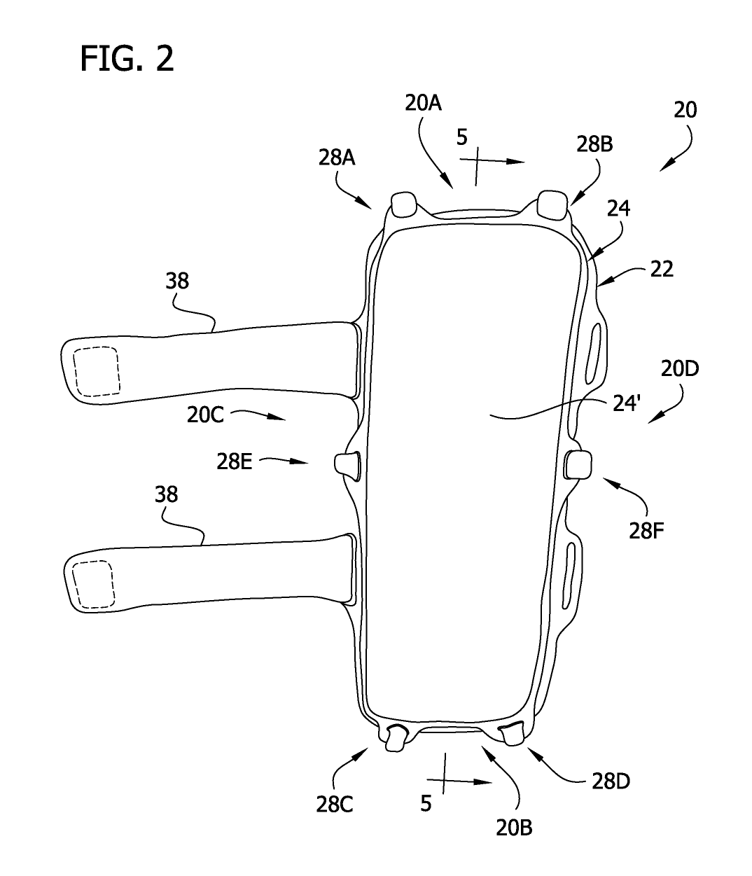

Referring to the drawings and in particular to FIGS. 1 and 2, a compression assembly for applying compression therapy to a body part of a wearer is generally indicated 20. As will be explained hereinafter, the compression assembly 20 may be used for intermittently or cyclically compressing a body part such as a limb (e.g., a leg or arm) although it is envisioned that it could be used for static compression applications. The body part referred to herein and shown in FIG. 1 is a leg, generally designated L.

The compression assembly 20 includes a bladder support, generally indicated by 22, and a bladder, generally indicated by 24. The bladder is fanned separately from the bladder support 22. The bladder 24 and bladder support 22 are configured so that the bladder is releasably mountable on the bladder support. For example, as shown in FIGS. 1 and 2, the bladder support 22 and the bladder 24 have multiple connections 28 formed by connection structure on the bladder and bladder support for mounting the bladder on the bladder support. Because the bladder 24 and the bladder support 22 are separate from one another, the bladder and bladder support are easily exchangeable and separately disposable. The bladder support 22 may be reused with several different bladders 24, or the bladder may be reused with several different bladder supports. For example, the bladder support 22 may be used for several different patients, and a new bladder 24 may be mounted on the bladder support for each new patient. Moreover, it may be desirable to install bladders having different configurations on the same bladder support 22 at different times for applying compression therapy of different types. The bladder support 22 may be reused for a period of days, months, or even years. For that reason, the bladder support 22 is preferably made of a material that allows for antiseptic cleaning.

FIG. 1 illustrates the compression assembly 20 in a self-retaining configuration or position about the leg L. The illustrated compression assembly 20 has a “knee length” size, i.e., the compression assembly extends generally from the ankle to below the knee. Compression assemblies of other sizes and shapes (e.g., “thigh length,” extending generally from the ankle to the thigh) may be used without departing from the scope of the present invention. When the compression assembly 20 is in the self-retaining configuration about the leg L, the bladder 24 is positioned between the bladder support 22 and the leg L such that pressurization of the bladder imparts compression to the leg.

FIG. 2 shows the compression assembly 20 removed from the leg L. The illustrated compression assembly 20 includes six connections 28A-28F of the bladder support 22 and bladder 24 for releasably mounting the bladder on the bladder support. The connections 28A-28F are spaced about the compression assembly 20. More specifically, two connections 28A, 28B are provided at an upper end 20A of the compression assembly 20, two connections 28C, 28D are provided at a lower end 20B of the compression assembly, and one connection 28E, 28F is provided on each side 20C, 20D of the compression assembly. Other numbers of connections and connections positioned differently about the compression assembly 20 may be used without departing from the scope of the present invention. Specific types of possible connections 28A-28F will be described in further detail hereinafter. As will become apparent, connection structure on the bladder (bladder connection structure) is engageable with connection structure on the bladder support (support connection structure) for securely but releasably mounting the bladder on the bladder support.

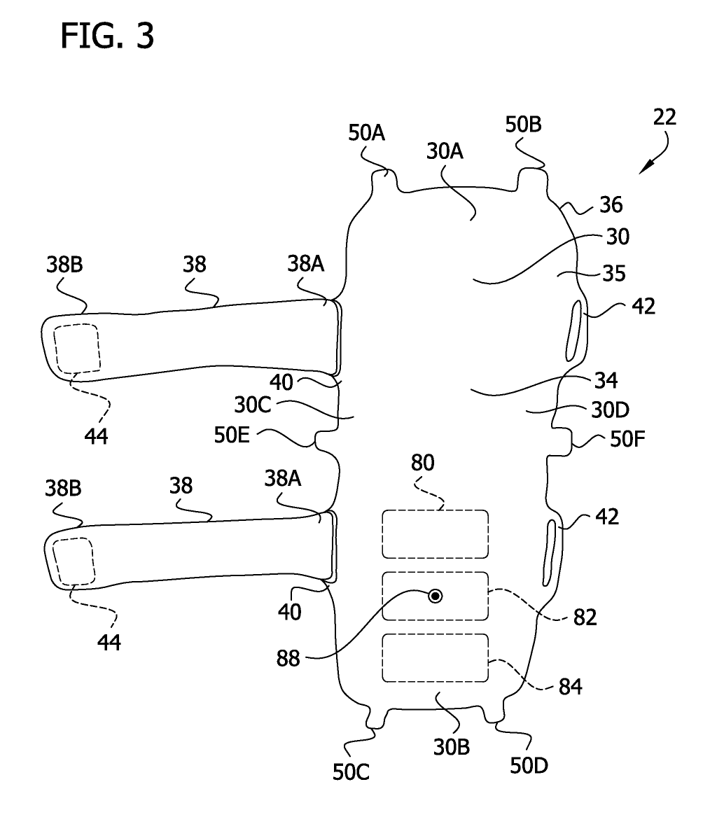

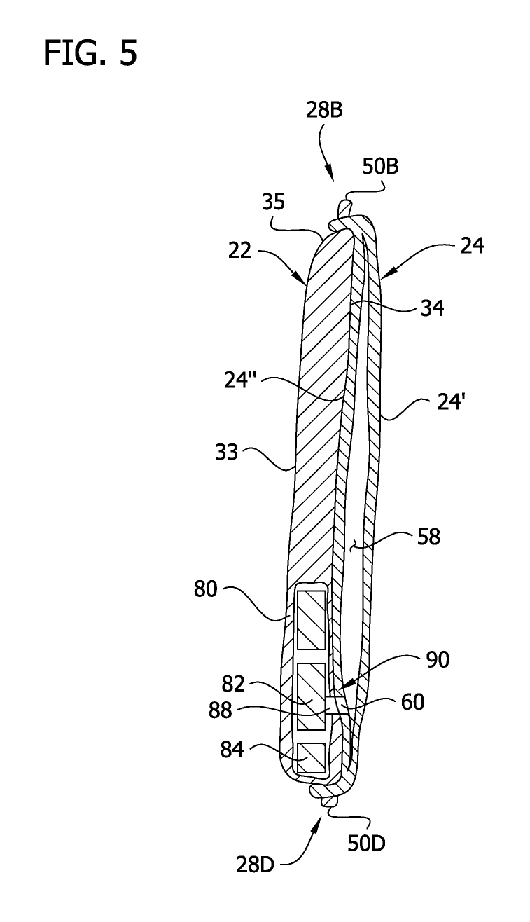

FIG. 3 shows the bladder support 22 having the bladder 24 removed or dismounted from the bladder support. The bladder support 22 comprises a body 30. The body 30 has upper and lower ends 30A, 30B, left and right sides 30C, 30D and a length extending between the upper and lower ends, and a width extending between the left and right sides. The body 30 may be shaped and contoured (e.g., curved) or be formed of a material suitable for generally conforming to the body part L when applied to the body part. The bladder support 22 has a rear surface 33 (FIG. 5) and a support surface 34 for supporting the bladder 24 such that expansion of the bladder is directed against the leg L for imparting compression to the leg. The bladder support 22 also has a peripheral edge margin 35 (FIGS. 1, 3, and 5), including a peripheral edge 36 (FIGS. 1 and 3). The peripheral edge extends along the upper and lower ends 30A, 30B and the left and right sides 30C, 30D of the bladder support 22. The peripheral edge margin 35 extends on the support surface 34 and on the rear surface 33 along the upper and lower ends 30A, 30B and the left and right sides 30C, 30D of the bladder support 22.

The bladder support 22 and/or bladder support surface 34 may be formed of a generally rigid material such as a molded plastic or of a semi-rigid material such as a silicone rubber. As used herein, the term “rigid” means substantially inflexible or resistant to bending or being forced out of shape, and the term “semi-rigid” means semi-flexible. Materials which are semi-rigid may be semi-resilient and/or inelastic. The rigid or semi-rigid nature of the bladder support 22 and/or support surface 34 facilitates mounting of the bladder on the bladder support, as will become apparent. However, use of a support which has different rigidity at different locations or even a non-rigid support may be used without departing from the scope of the present invention. In general, the bladder support 22 is more rigid than the bladder 24. In other words, the bladder support 22 is less flexible than the bladder 24 or resists bending more than the bladder. Desirably, the bladder support 22 has rigidity sufficient for tensioning the bladder 24 when the bladder is mounted on the bladder support. For example, the bladder support 22 may have rigidity sufficient for overcoming elasticity of the bladder 24, which is described in further detail below, for maintaining the bladder in a tensioned state when it is mounted on the bladder support. The bladder support 22 may not be more rigid than the bladder 24 without departing from the scope of the present invention.

In the illustrated embodiment, the support surface 34 extends across approximately all of the bladder support body 30. The support surface 34 has a length extending from the upper end 30A to the lower end 30B, and a width extending from the left side 30C to the right side 30D. Bladder supports having bodies of other shapes and configurations may be used without departing from the scope of the present invention. For example, other bladder supports may have support surfaces which extend across only a portion of the body, such as a portion of the height or width of the bladder support.

The bladder support 22 includes two fastening assemblies for securing the compression assembly 20 about the leg L in the self-retaining configuration. The fastening assemblies in the illustrated embodiment include straps 38. As shown in FIG. 3, a first end 38A of each strap 38 is connected to the bladder support 22 at a respective first loop 40 on the body 30. To secure the compression assembly 20 on a body part L, the straps 38 are wrapped about the body part, and a second end 38B of each strap 38 is threaded through a respective second loop 42 on the body 30. As shown in FIG. 1, the second ends 38B are folded back over the straps 38, and hook fabric 44 on the second ends is engaged with loop fabric on the straps. The straps 38 may be nondestructively removed from the body 30. Alternatively, the straps 38 may be formed as integral components with the body 30. Different numbers of straps 38 and straps having other configurations may be used without departing from the scope of the present invention. Moreover, fastening assemblies other than straps may be used.

The bladder support 22 further includes protrusions 50 (broadly “connection structure”) spaced about the bladder support for forming the connections 28A-28F with the bladder 24 for releasably mounting the bladder on the bladder support. In the illustrated embodiment, the bladder support 22 includes six protrusions or tabs 50A-50F, but other numbers may be used. The tabs 50A-50F are located generally about the peripheral edge margin 35 of the bladder support 22. More specifically, in the illustrated embodiment, the tabs 50A-50F extend outward from the peripheral edge 36 of the bladder support 22. Tabs positioned at other locations along the peripheral edge margin 35 (on the bladder support surface 34) or on rear surface 33 may be used without departing from the scope of the present invention.

The tabs 50A-50F of the embodiment shown in FIGS. 1-5 have a generally flat construction of constant width and depth. The tabs 50A-50F extend radially outward from the peripheral edge 36 in generally the same plane as the support surface 34. The tabs 50A-50F may extend outward from the peripheral edge 36 at an angle with respect to the support surface 34 so that the tabs extend away from the body part L when the bladder support 22 is placed on the body part. Tabs may have other constructions and configurations within the scope of the present invention.

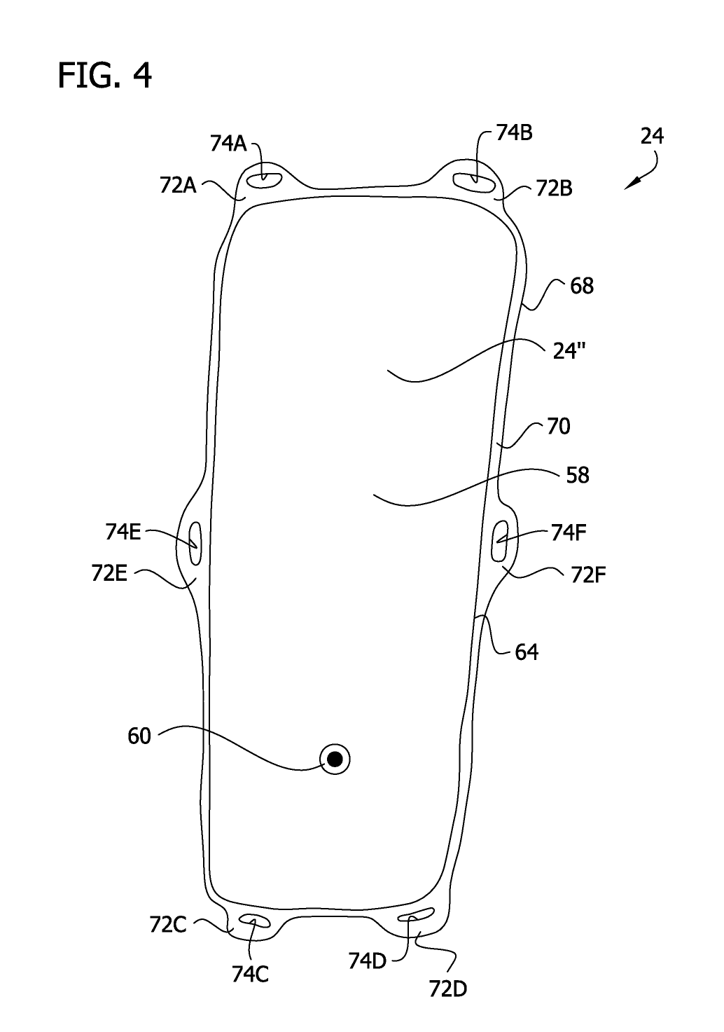

FIG. 4 illustrates the bladder 24 separate from the bladder support 22. The bladder 24 includes a main body having a front wall defining a front surface 24′ (FIG. 5) and a rear wall defining a rear surface 24″. The rear surface 24″, which is shown facing out of the page in FIG. 4, is supported by the bladder support 22, and more particularly the support surface 34, when the bladder 24 is mounted on the bladder support. The rear surface of the bladder 24″ is shown engaging the support surface 34 in FIG. 5. The bladder 24 includes an inflatable chamber 58 and a port 60 providing fluid communication with the inflatable chamber. The bladder 24 may be constructed in any suitable manner. In one embodiment the bladder is constructed by positioning two sheets of fluid impermeable material such as PVC (defining the front and back surfaces of the bladder 24′, 24″) over one another and welding the sheets together about a line 64 (FIG. 4) defining the inflatable chamber 58 between the sheets. The bladder 24 has a peripheral edge 68. The bladder also has a peripheral edge margin 70 extending along upper and lower ends and sides of the bladder. The peripheral edge margin 70 includes the peripheral edge 68 and includes flaps 72A-72F extending outward from the main body of the bladder 24. The bladder 24 has openings or eyelets 74 (broadly “connection structure”) generally in the flaps 72A-72F for forming the connections 28A-28F with the bladder support 22. In the illustrated embodiment, the bladder includes six eyelets 74A-74F, which are holes through the bladder material and are located on the flaps 72A-72D, but may comprise other types of openings (e.g., pockets) and may be positioned elsewhere on the bladder 24. It is understood that the connection structure of the bladder support and the bladder may be changed, i.e., the bladder support may include openings and the bladder may include protrusions, without departing from the scope of the present invention.

The tabs 50A-50F on the bladder support 22 and the eyelets 74A-74F on the bladder 24 are sized and shaped for push-in reception of the tabs in the eyelets and nondestructive release of the tabs from the eyelets. Reception of the tabs 50A-50F in the eyelets 74A-74F forms the connections 28A-28F for releasably mounting the bladder 24 on the bladder support 22. Engagement of the bladder connection structure and the support connection structure mounts the bladder 24 securely on the bladder support 22 such that the rear surface 24″ of the bladder is substantially prevented from moving (e.g., lengthwise or widthwise) along the support surface 34. The eyelets 74A-74F may have a shape generally corresponding to the cross-sectional shape of the tabs 50A-50F. In the illustrated embodiment, the tabs 50A-50F have a generally rectangular cross section that is generally constant along the length of the tabs, and the eyelets 74A-74F have a corresponding elongate shape sized approximately the same as the cross section of the prongs. Alternatively, the openings 74A-74F may be sized smaller than the cross section of the tabs 50A-50F so that push-in reception of the tabs in the eyelets forms a releasable, interference fit of the tabs in the eyelets. Friction between the eyelets 74A-74F and the tabs 50A-50F can also help to maintain the tabs in the eyelets.

The connection structures of the bladder 24 and bladder support 22 may be arranged so that the bladder is held in tension when the bladder is mounted on the bladder support. For example, the tabs 50A-50F may be arranged and spaced from each other on the bladder support 22 so that the bladder 24 needs to be tensioned as it is mounted on the bladder support 24. In other words, the spacing between the tabs 50A-50F may be greater than the spacing between corresponding eyelets 74A-74F that receive the tabs. The bladder 24 may remain in tension (residual tension) when mounted on the bladder support 22. This arrangement assists in maintaining the bladder 24 securely mounted on the bladder support 22 and in position on the bladder support relative to the support surface 34. In other words, the arrangement prevents the eyelets 74A-74F from being inadvertently removed from the tabs 50A-50F. Tension may not be maintained in the bladder 24 when mounted on the bladder support 22 without departing from the scope of the present invention.

Tension is created, for example, by pushing the eyelets 74A, 74B in the upper end of the bladder 24 onto the tabs 50A, 50B on the upper end of the bladder support 22 and grasping and tensioning the bladder in a longitudinal direction by pulling the lower end of the bladder 24 toward the lower end of the bladder support 22. The tips of the tabs 50C, 50D on the lower end of the bladder support 22 are spaced from the bases of the tabs 50A, 50B on the upper end of the bladder support a distance greater than the separation of the upper eyelets 74A, 74B from the lower eyelets 74C, 74D. To remove the bladder 24 from the bladder support 24, sufficient longitudinal tension would need to be reapplied to the bladder (e.g., by pulling on the lower end of the bladder 24 downward) to remove the eyelets 74C, 74D from the tabs 50C, 50D. The tips of the tabs 50C, 50D may be spaced from the bases of the tabs 50A, 50B such that residual tension remains in the bladder 24 when the eyelets 74A-74D are fully seated on respective tabs 50A-50D. To remove the bladder 24 from the bladder support 24, tension greater than the residual tension would need to be applied. The requirement for actively applying tension to the bladder to remove it from the bladder support prevents inadvertent dismounting of the bladder from the bladder support.

Alternatively or in addition, the bladder support 22 and bladder 24 may be configured similarly with respect to the tabs 50E, 50F (positioning and spacing) on the sides of the bladder support 22C, 22D and the eyelets 74E, 74F in the sides of the bladder 24C, 24D so that the bladder is tensioned in a lateral direction between the sides of the bladder. Desirably, the tabs 50A-50F are positioned on the bladder 22 support such that the bladder 24 needs to be tensioned between at least two of the eyelets while the bladder is being mounted on the bladder support. However, embodiments where the bladder 24 is not tensioned when mounted on the bladder support 22 may be used without departing from the scope of the present invention. For purposes of this description, sliding the eyelets 74A-74F onto the tabs 50A-50F and pushing tabs into eyelets (not shown in FIGS. 1-5) are considered “push-in” connections.

Desirably, at least a portion of the bladder 24 is resiliently elastic to facilitate maintaining the bladder mounted on the bladder support 22. For example, the front and rear walls of the bladder 24 may be formed of resiliently elastic material such as PVC. The elasticity permits the bladder 24 to be at least minimally stretched during mounting of the bladder on the bladder support 22. The resiliency causes the bladder 24 to tend to resume its original size and shape. In some embodiments, such as some embodiments described herein, the resilient elasticity prevents the connection structure of the bladder 24 from disengaging from the connection structure of the bladder support 22. For example, the resilient elasticity may cause the eyelets 74A-74F to remain on the tabs 50A-50F. The resilient elasticity also permits stretching of the bladder 24 for removing the eyelets 74A-74F from the tabs 50A-50F. The bladder 24 may not be resiliently elastic without departing from the scope of the present invention.

Referring again to FIG. 3, the bladder support 22 includes a controller 80, a source of pressurized gas 82 (e.g., a pump), and a power supply 84 (e.g., a battery) that are all supported on and portable with the bladder support 22. These components are also schematically illustrated in the section shown in FIG. 5. For example, the controller 80, source of pressurized gas 82, and power supply 84 may be received in a recess in the bladder support 22 and covered by a removable cover (not shown). The controller 80, source of pressurized gas 82, and power supply 84 are operatively connected so that the source of pressurized gas can deliver pressurized gas to pressurize the inflatable chamber 58 and the controller can control such delivery of pressurized gas to the inflatable chamber as desired. The controller 80 may be programmed to provide a constant pressure in the inflatable chamber 58. The controller may also be programmed to pressurize the inflatable chamber 58 in a cyclic or intermittent fashion. The controller 80 may or may not include a valve (not shown) for selectively directing pressurized gas to the inflatable chamber 58.

The bladder support 22 includes a port 88 (FIG. 3) positioned on the bladder support 22 and configured such that the port makes a direct connection with the port 60 of the bladder 24 (FIG. 4) when the bladder is mounted on the bladder support. An example of a direct connection 90 is illustrated in FIG. 5. The direct connection 90 between the ports 60, 88 provides direct, sealed fluid communication between the source of pressurized gas 82 and the inflatable chamber 58. Such a direct connection 90 eliminates the need for a length of flexible conduit extending between the two ports, which may become tangled, although such a conduit may be used, such as when a pump is remote from the bladder support.

In use, the compression assembly 20 is used for applying therapeutic compression on a leg L for improving flow of bodily fluid such as blood in the body part. The bladder 24 is mounted on the bladder support 22 by pushing the tabs 50A-50F on the bladder support into the eyelets on the bladder 74A-74F, Pushing the tabs 50A-50F into the eyelets 74A-74F may cause the bladder 24 to be held in tension on the bladder support 22. The compression assembly 20 is then applied to the leg L. The straps 38 extending from the bladder support 22 are adjusted around the leg L to secure the bladder support 22 and the bladder 24 to the leg in the self-retaining configuration for application of therapeutically efficacious compression to the leg. For example, adjusting the straps 38 may include sizing a length of the straps around the leg L to fit a particular circumference of the leg. This allows the same compression apparatus to be used on legs of many different sizes. Adjusting the straps 38 may include simply wrapping the straps around a portion of the body part and fastening them to an opposite side of the bladder support. The source of pressurized gas 82 (e.g., a pump) is activated (e.g., by use of the controller 80 and power source 84) to apply therapeutically efficacious compression to the leg L. For example, the pump 82 may cyclically inflate and deflate the bladder 24 to compress the leg L to promote blood movement.

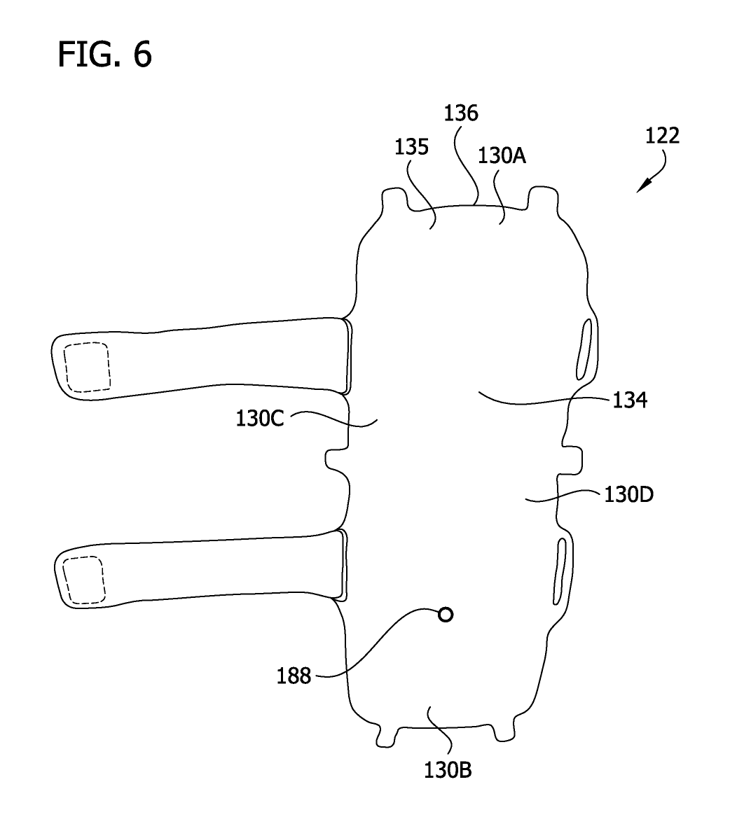

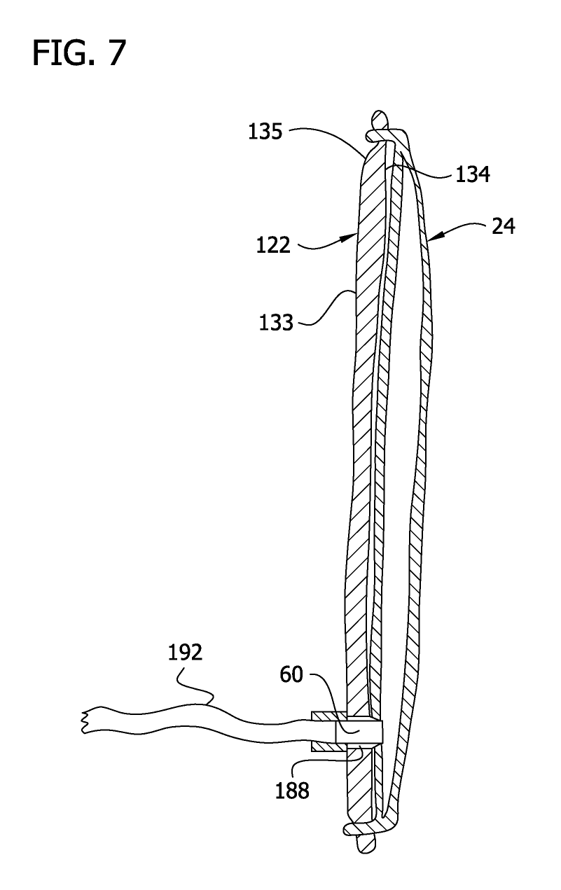

FIGS. 6 and 7 illustrate a second embodiment of a bladder support 122 of the present invention. The bladder support 122 is generally similar to the bladder support 22 described above, and corresponding parts are generally indicated by the same reference numbers, plus 100. For example, the bladder support 122 includes a support surface 134 and a peripheral edge margin 135 including a peripheral edge 136. The peripheral edge extends along the upper and lower ends 130A, 130B and the left and right sides 130C, 130D of the bladder support 122. The peripheral edge margin 135 extends on the support surface 134 and on the rear surface 133 (FIG. 7) along the upper and lower ends 130A, 130B and the left and right sides 130C, 130D of the bladder support 122. In this embodiment, the bladder support 122 does not include a controller 80, source of pressurized gas 82, or power source 84. The bladder 24 may be suitable for use with the bladder support 122. With the bladder support 122, the bladder 24 is not fluidly coupled to a source of pressurized gas that is supported on the bladder support 122. Instead, the bladder 24 may be fluidly coupled to a source of pressurized gas separate from the bladder support 122. For example, the port 60 on the bladder 24 may be connected via a length of conduit 192 to a housing containing the controller, source of pressurized gas, and power source that is located remotely from the bladder support 122, such as on a bed rail of a bed in which the wearer is lying (not shown). In this embodiment, the port 188 on the bladder support 122 comprises a hole in the bladder support through which the port 60 on the bladder 24 is accessible for connection in fluid communication with the source of pressurized gas.

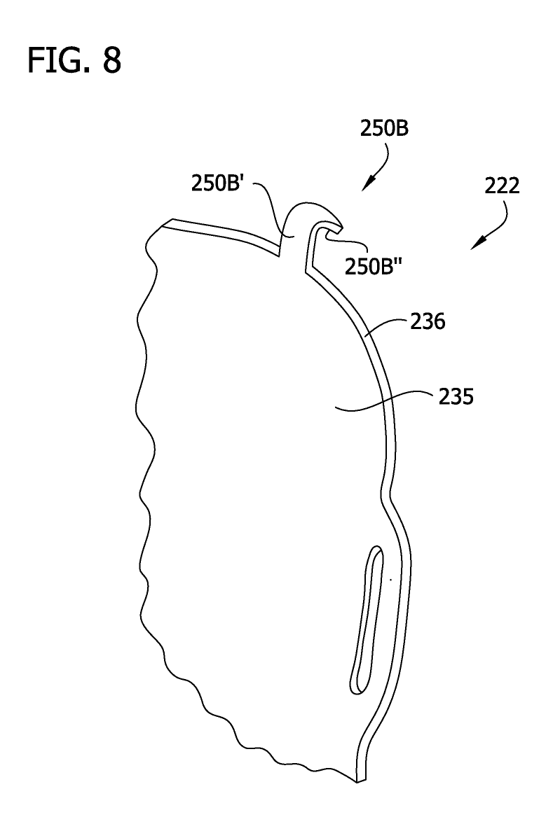

FIG. 8 is a fragmentary perspective of a third embodiment of a bladder support 222 of the present invention. The bladder support 222 may have a construction generally similar to those of the first two embodiments of the bladder support 22, 122. Corresponding parts are generally indicated by the same reference numbers, as for the first embodiment, plus 200. In this embodiment, the protrusions (only 250B being shown) take the form of hooks 50A-50F on the bladder support 222. The hooks 50A-50F are located about the peripheral edge margin 235 of the bladder support, and more particularly extend outward from the peripheral edge 236. The hook 250B comprises a base 250B′ connected to the body 230 of the bladder support 222 and a retainer 250B″ extending at an angle with respect to the base. Although only one hook 250B is illustrated, it is understood that similar hooks could replace each of the tabs 50B-50F to form connections with the bladder 24 similar to each connection 28A-28F. A bladder 24 having eyelets such as the eyelets 74A-74F illustrated in FIG. 4 would be suitable for mounting on the bladder support 222 of this embodiment using the hooks like hook 250B. Like the tabs 50A-50F described above, the hook 250B is sized and shaped for releasable push-in reception of the hook in one of the eyelets 74B, and reception of the hook 250B in the eyelet 74B releasably mounts the bladder 224 on the bladder support 222, perhaps in a tensioned state, as described above. Push-in reception of the hooks like hook 250B in the eyelets 74A-74F forms a releasable, interference fit of the hooks in the eyelets. The retainer 250B″ hinders movement of the eyelet 74B off the hook 250B. Hooks sized and shaped differently than shown are within the scope of the present invention.

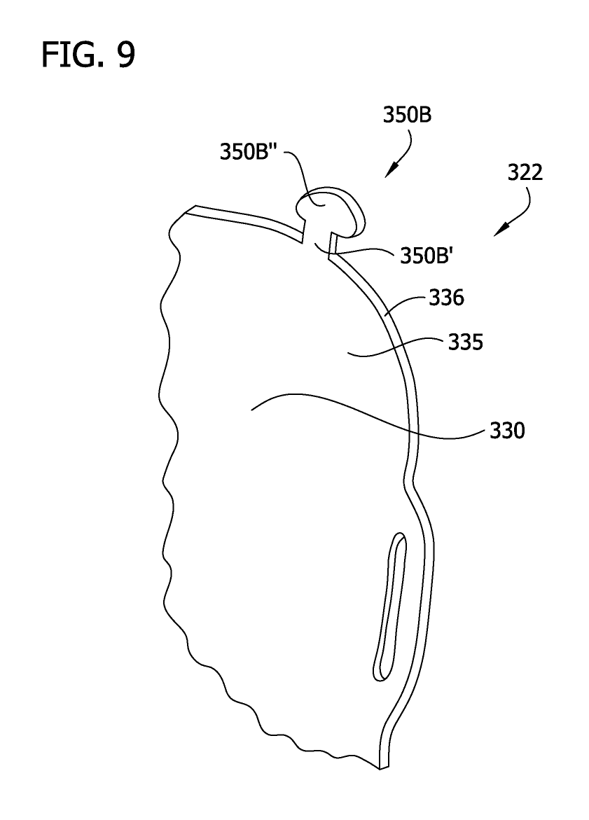

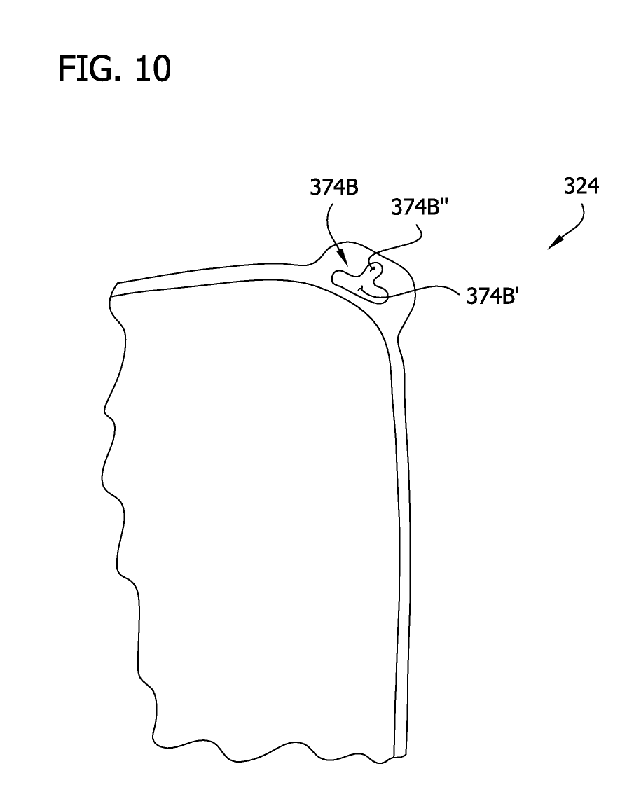

FIG. 9 is a fragmentary perspective of a fourth embodiment of a bladder support 322 of the present invention. The bladder support 322 may have a construction generally similar to those of the first two embodiments of the bladder support 22, 122. Corresponding parts are generally indicated by the same reference numbers, as the first embodiment, plus 300. In this embodiment, the protrusions on the bladder support 322 take the form of keys (only 350B being shown). The keys are located about the peripheral edge margin 335 of the bladder support 322, and more particularly extend outward from the peripheral edge 336. The illustrated key 350B has a mushroom-like shape. The key 350B comprises a base 350B′ connected to the body 330 of the bladder support 322 and a retainer 350B″ connected to the base and spaced from the body. The retainer 350B″ has a leading end and a retaining end connected to the base 350B′. The leading end is generally rounded to facilitate connection of the key 350B and the bladder 324 (FIG. 10). The retaining end includes opposite retaining edges projecting transversely from the top of the base 350B′. Only one key 350B is illustrated, but it is understood that similar keys could be used to form connections with the bladder 324 similar to each of the connections 28A-28F described above.

FIG. 10 illustrates a bladder 324 suitable for use with the bladder support 322 shown in FIG. 9. The bladder 324 may have a construction generally similar to the bladder 24 illustrated in FIG. 4. Corresponding parts are generally indicated by the same reference numbers, as the first embodiment, plus 300. In this embodiment, the bladder 324 has openings (only 374B being shown) that are keyholes (also indicated 374B) corresponding to the keys 350B on the bladder support 322. The key 350B and keyhole 374B are configured such that they form a particular releasable, push-in reception of the key in the keyhole. Push-in reception of the key 350B in the keyhole 374B forms a releasable, interference fit of the key in the keyhole. In the illustrated embodiment, the keyhole 374B is generally T-shaped. The keyhole 374B includes an entry portion 374B′ and a retaining portion 374B″. The key 350B is inserted into the keyhole 374B by passing the wide retainer 350B″ through the wide entry portion 374B′ of the keyhole so that the base 350B′ of the key 350B is disposed within the entry portion. The entry portion 374B′ may be sized larger than, approximately equal to, or slightly smaller than the retainer 350B″ such that the retainer may pass through the entry portion without substantial deformation (e.g., stretching) of the keyhole 374B. The base 350B′ is then moved into the retaining portion 374B″ of the keyhole 374B. This process may be repeated for each key and keyhole connection similar to the connections 28A-28F. The keyholes such as keyhole 374B may be spaced from one another such that the bladder 324 is in a tensioned state on the bladder support 322 when the base 350B′ is retained in the retaining portion 374B″ of the keyhole 374B. In the illustrated embodiment, the retaining portion 374B″ is outboard of the entry portion 374B′ so that tension tending to pull the keyhole 374B inboard maintains the base 350B′ in the retaining portion. Keyholes positioned elsewhere on the bladder may be oriented in a similar fashion with respect to the location on the bladder 324 in which the keyholes are positioned such that tension in the bladder would tend to maintain bases of respective keys in the retaining portions of the keyholes. To remove the bladder 324 from the bladder support 322, the keyhole may be moved radially outward with respect to the bladder support to move the base 350B′ of the key 350B back into the entry portion 374B′ of the keyhole 374B. In this position, the key 350B may be removed from the keyhole 374B by passing the retainer 350B″ back through the entry portion 374B′.

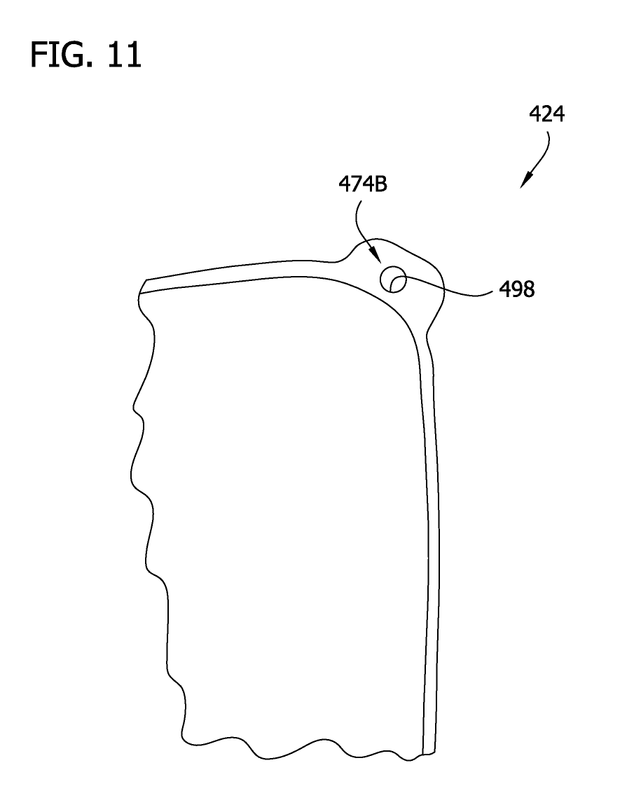

FIG. 11 illustrates another embodiment of a bladder 424. The bladder 424 may have a construction generally similar to the bladder 24 illustrated in FIG. 4. Corresponding parts are generally indicated by the same reference numbers, plus 400. In this embodiment, the bladder 424 has openings (only 474B being shown) that are eyelets through the bladder material. The eyelets may be suitable for protrusions of any of the bladder supports described herein, but will be described in particular with respect to the key 350B of the bladder support 322 illustrated in FIG. 9. The eyelet 474B forms a particular type of releasable push-in reception with the key 350B. Push-in reception of the key 350B in the eyelet 474B forms a releasable, interference fit of the key in the eyelet. The eyelet 374B is sized such that passing the retainer 350B″ of the key 350B through the eyelet requires temporary deformation of the eyelet. For example, the rounded leading end of the key 350B may be pressed against the eyelet 474B, which causes the bladder material to stretch, temporarily enlarging the eyelet. In this way, the retainer 350B″ may pass through the eyelet 474B such that the base 350B′ is disposed within the eyelet and retaining edges of the key 350B overlie an edge margin 498 of the eyelet and hinder the eyelet from moving off the key. The eyelet 474B resumes its original shape and size after the retainer 350B″ passes through the eyelet. The bladder 424 may be removed from the bladder support 322 by forcing the eyelet 474B past the retaining edges to remove the retainer 350B″ from the hole. With this embodiment of the bladder 424, it may be desirable to provide a retaining portion on the key 350B that resembles a cone (not shown) so that instead of having only two retaining edges there is an annular retaining surface extending around all sides of the base 350B′ for overlying bladder material 498 on all sides of the eyelet 474B.

The several types of protrusions (e.g., 50, 150, 250, 350) described herein may be used on any one bladder support (e.g., 22, 122) in any combination without departing from the scope of the present invention. In other words, a particular bladder support may include only one type of protrusion, or the bladder support may have one or more types of protrusions for connecting with a bladder having corresponding openings (e.g., 74, 374, 474), depending on the desired configuration.

In alternative embodiments, the protrusions (e.g., 50, 150, 250, 350) are associated with the bladder and the openings (e.g., 74, 374, 474) are associated with the bladder support. In other words, the protrusions are on the bladder instead of on the bladder support, and the openings are on the bladder support instead of the bladder. Moreover, protrusions and openings could both be provided on the bladder support, and corresponding openings and protrusions could be provided on the bladder.

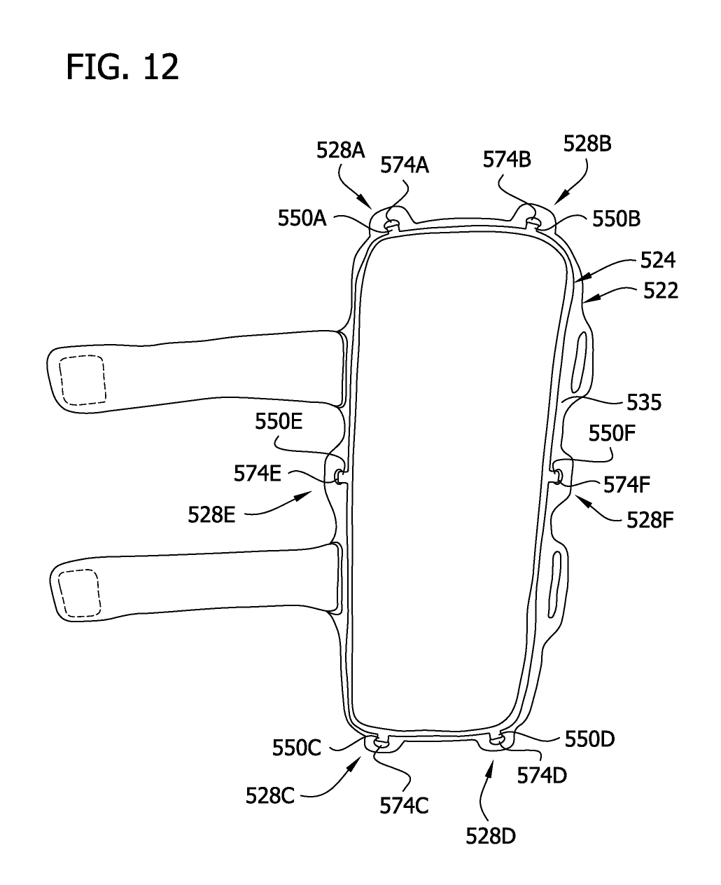

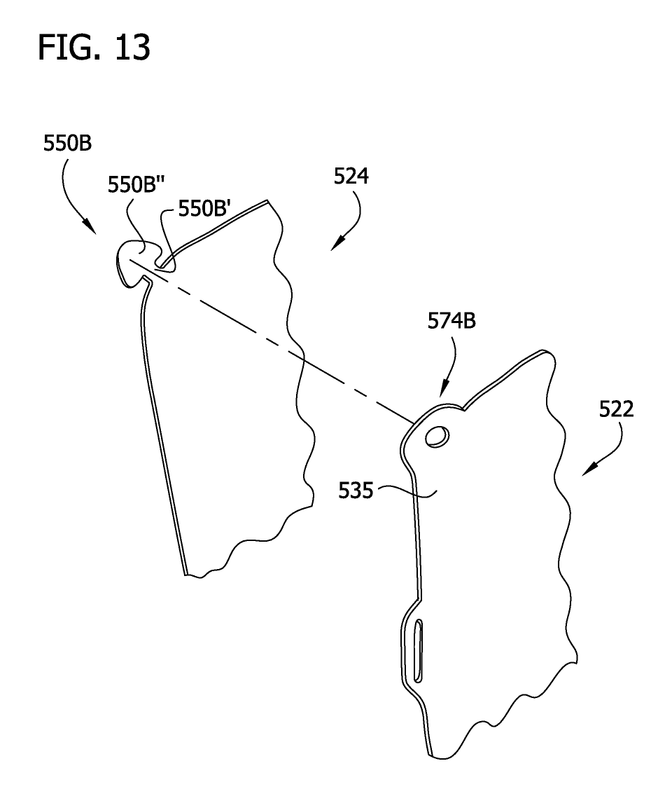

FIGS. 12 and 13 illustrate another embodiment of the bladder support 522 and a corresponding bladder 524 (corresponding parts generally indicated by the same reference numbers, as in the first embodiment, plus 500) in which the connections 528A-528F between the bladder 524 and bladder support 522 are formed by protrusions 550A-550F on the bladder and openings 574A-574F on the bladder support. More specifically, protrusions in the form of keys 550A-550F similar to the key 350B shown on the bladder support 322 in FIG. 9 are provided on the bladder 524. The openings 574A-574F are provided in the form of eyelets. Push-in reception of the keys 550A-550F in the eyelets 574A-574F forms a releasable, interference fit of the keys in the eyelets. The eyelets 574A-574F are holes through the bladder support 522. The eyelets are located about the peripheral edge margin 535 of the bladder support 522. Referring to FIG. 13, a rear fragmentary perspective of the bladder 524 separated from the bladder support 522, the key 550B includes a base 550B′ and an enlarged retainer 550B″ having a leading end and a retaining end attached to the base. The key 550B is inserted in the eyelet 574B by bending the key at the base 550B′ to orient the leading end toward the eyelet and pressing the key against the eyelet to pass the retainer 550B″ through the eyelet. The retainer 550B″ is desirably sized larger than the eyelet 574B. The key 550B″ may be made of deformable, resilient material so that the retainer 550B″ resumes its original shape after passing through the eyelet 574B. Alternatively, the eyelet 574B may be deformable and resilient. The retainer 550B″ resists movement out of the eyelet 574B similar to the key 350B described above with respect to the eyelet 474B. This process is repeated for inserting the keys 550A-550B spaced about the bladder 524 into corresponding eyelets 574A-574F positioned about the bladder support 522. The bladder 524 is removed from the bladder support 522 by deforming each retainer 550B″ or eyelet 574 to pass the retainers through the eyelets to remove the keys from the eyelets.

Other types of protrusions, such as protrusions described in previous embodiments may be used on the bladder. Moreover, other types of openings may be used on the bladder support.

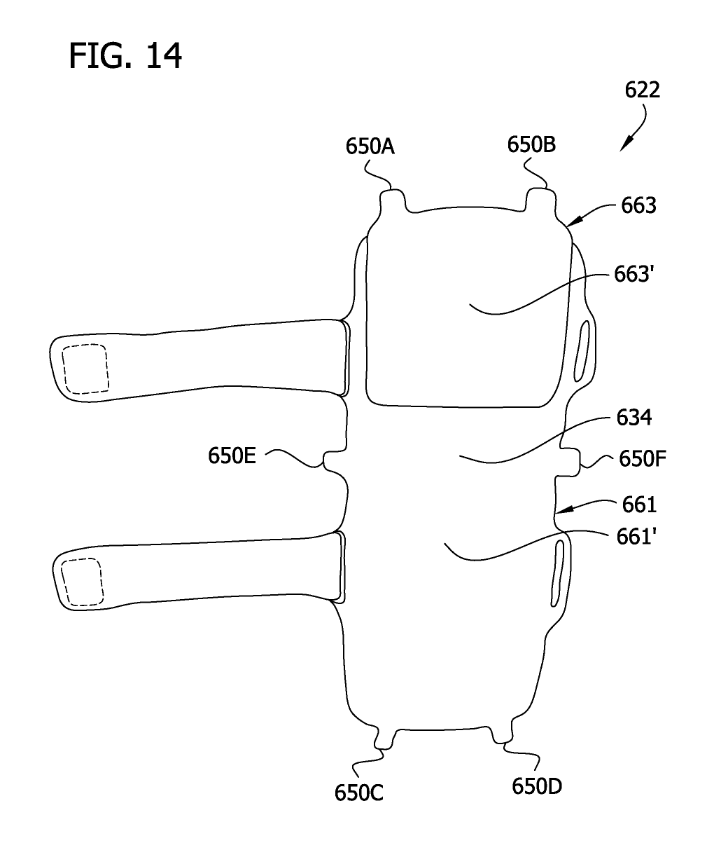

FIGS. 14-19 illustrate a fourth embodiment of a bladder support 622 of the present invention. The bladder support may have a construction generally similar the bladder support embodiments discussed above. Corresponding parts are generally indicated by the same reference numbers as the first embodiment, plus 600. Referring to FIG. 14, in this embodiment, the bladder support 622 body includes a base 661 and an extension 663. The base and extension both define at least part of the support surface 634. The base 661 defines a first portion of the support surface 661′, and the extension defines a second portion of the support surface 663′ above the first portion. The extension 661 is selectively movable with respect to the base 663 to adjust the length of the bladder support 622. This construction permits for adjustment of the support surface 634 for conforming to bladders having different lengths.

Still referring to FIG. 14, as with previous embodiments, the bladder support 622 has support connection structure for engaging bladder connection structure for securely mounting a bladder on the support. The bladder support connection structure is provided on the base 661 and the extension 663. In the illustrated embodiment, the support connection structure comprises two protrusions in the form of tabs 650A, 650B on an upper end of the extension 663 and tabs 650C, 650D on a lower end of the base 661.

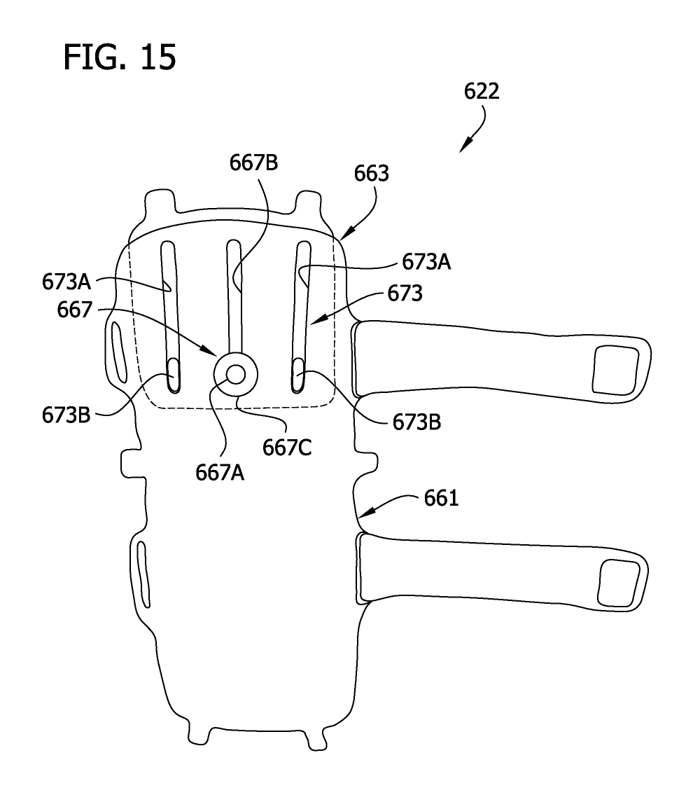

FIG. 15 illustrates a rear elevation of the bladder support 622. The bladder support includes length fixation structure, generally indicated by 667, for selectively securing or locking the extension 663 in position with respect to the base 661. In the illustrated embodiment, the securement structure 667 includes a bolt 667A extending from a rear surface of the extension 663 which extends through a generally vertical slot 667B in the base 661. The securement structure 667 also includes a nut 667C which is threadable on the bolt 667A. When tightened, the nut 667C clamps the extension 663 against the base 661 for temporarily fixing the extension in place with respect to the base. When the nut 667C is loosened, the extension 663 is movable vertically with respect to the base 661 to adjust the length of the support surface 634 to conform to a length of a selected bladder. For example, a bladder may be selected from a variety of bladders having different lengths because the bladder has a length which generally corresponds to the length of a desired target compression zone on a body part of a person. The bladder support 622 can be adjusted in length to conform to the length of the selected bladder so the connection structure of the bladder support and the bladder are in suitable registration with each other for mounting the bladder on the bladder support and for providing the support surface 634 with a suitable length for supporting the rear surface of the bladder.

The bladder support 622 also includes guide structure, generally indicated by 673, for guiding movement of the extension 663 with respect to the base 661. In the illustrated embodiment, the guide structure 673 includes two guides 673A in the form of generally vertical slots in the base 661 and two guide members 673B extending from the rear surface of the extension 663 and received in the guides. The guide structure 673 maintains alignment of the extension 663 with respect to the base 661 as the extension is moved vertically (upward or downward) with respect to the base.

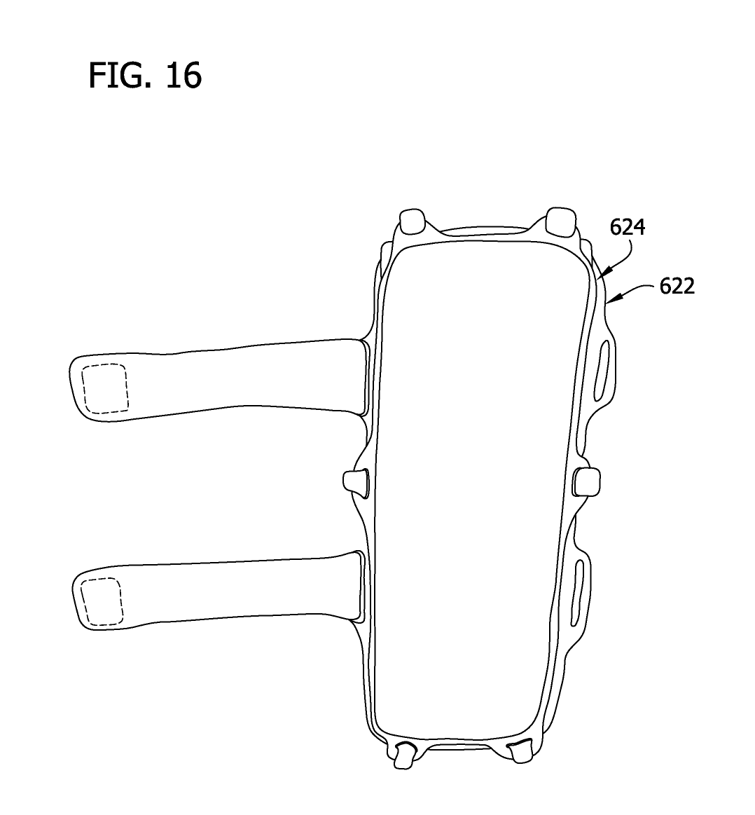

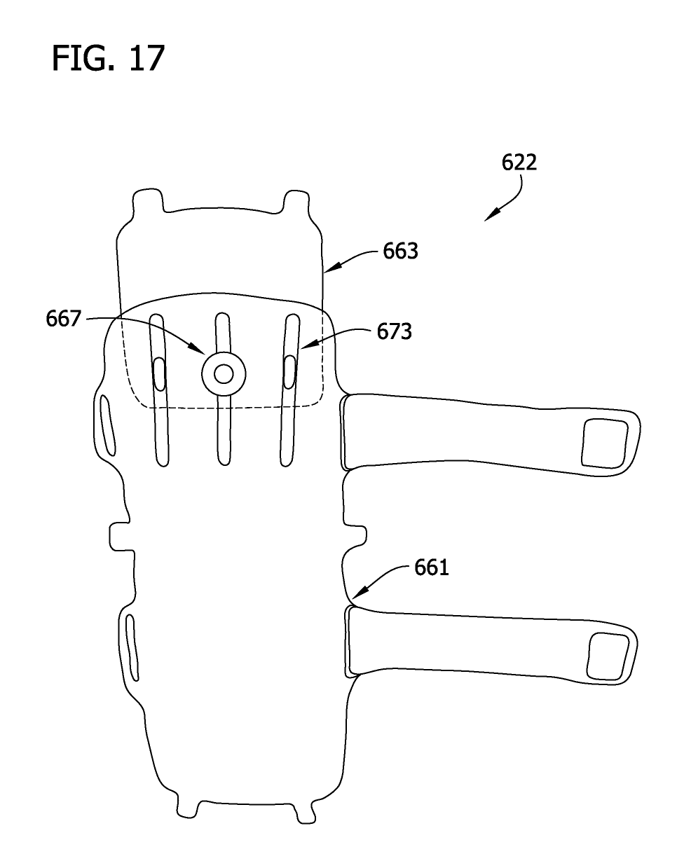

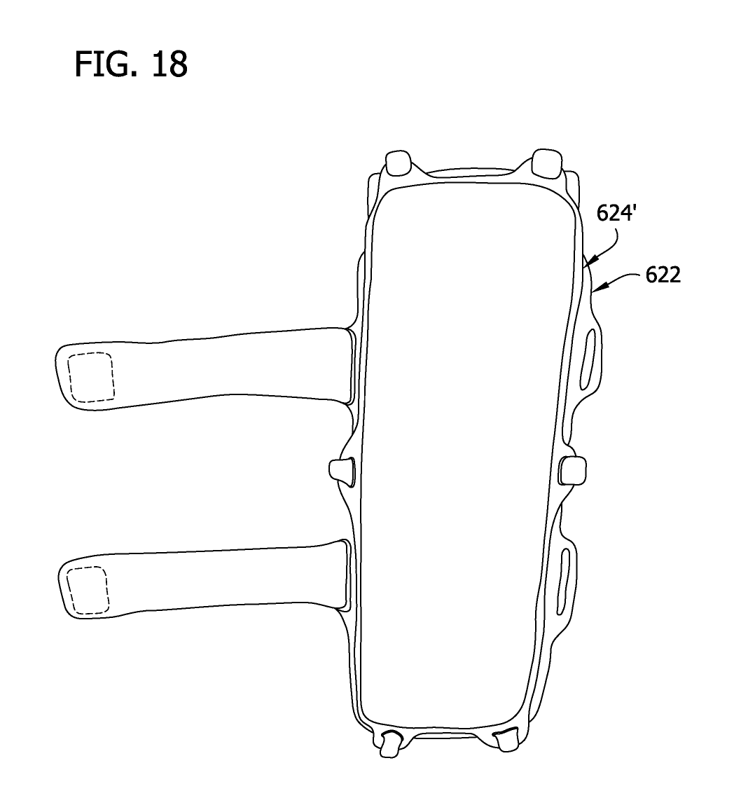

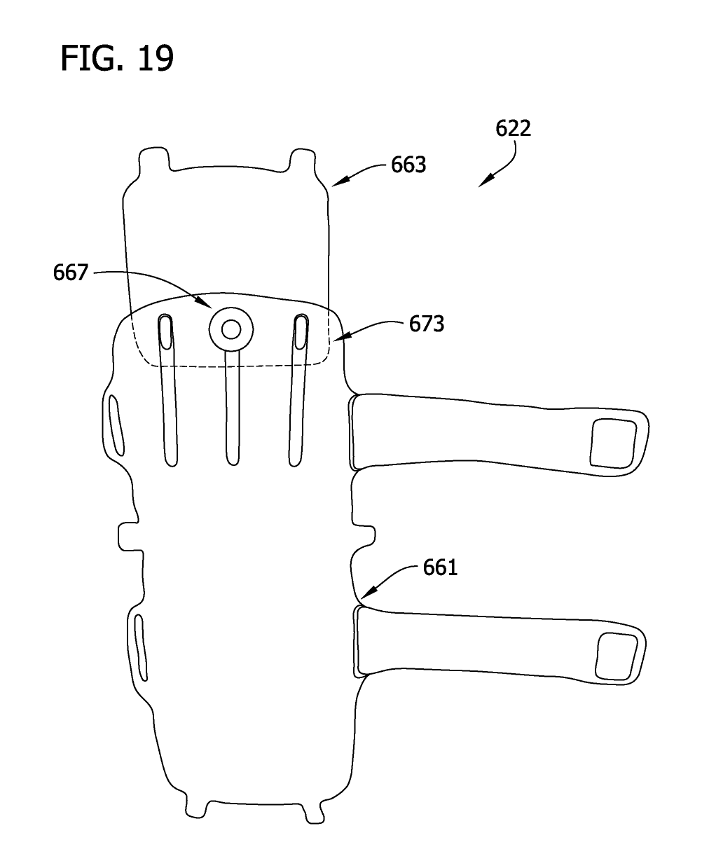

FIGS. 14-19 illustrate three different positions of the extension 663 with respect to the base 661. The extension 663 is shown in a fully retracted position in FIGS. 14-16, an intermediate position in FIGS. 17 and 18, and a fully extended position in FIG. 19. In the fully retracted position, the bladder support 622 has its shortest length. For example, the bladder support 622 may be used in this position with a “small” size bladder having a relatively short length. FIG. 16 illustrates a “small” bladder 624 on the bladder support. The bladder may have a construction generally the same as the bladder 24 shown in FIG. 4 but having a “small” size including a relatively short length. FIG. 17 is a rear elevation of the bladder support 622 showing the extension 663 moved to an example intermediate position. It is understood the extension 663 may be moved to other intermediate positions between the fully retracted and fully extended positions. In this intermediate position, the bladder support 622 may be used with a “medium” sized bladder having a length longer than a “small” bladder. FIG. 18 is a front elevation of the bladder support 622 in the configuration of FIG. 17 showing such a “medium” sized bladder 624′ mounted on the bladder support. The bladder 624′ may have a construction generally the same as the bladder 24 shown in FIG. 4 but having a “medium” size including a medium length. FIG. 19 is a rear elevation of the bladder support 622 showing the extension moved to the fully extended position. In this position, the bladder support 622 may be used with a “large” sized bladder having a relatively long length. Such a bladder is not shown mounted on the bladder support with the extension 663 in this position, but it is understood such a bladder may be mounted on the bladder support in a similar fashion as the other bladders. Moreover, the bladder support 622 may be used with bladders that are adjustable in length, as described in further detail below.

Bladder supports having other length fixation structure and/or guide structure may be used without departing from the scope of the present invention. For example, the length fixation structure may include clamps, fasteners, or other fixation means for locking the extension in position with respect to the base. Alignment markings (not shown) may be provided on the base 661 and/or the extension 665 to assist in adjusting them to the proper length.

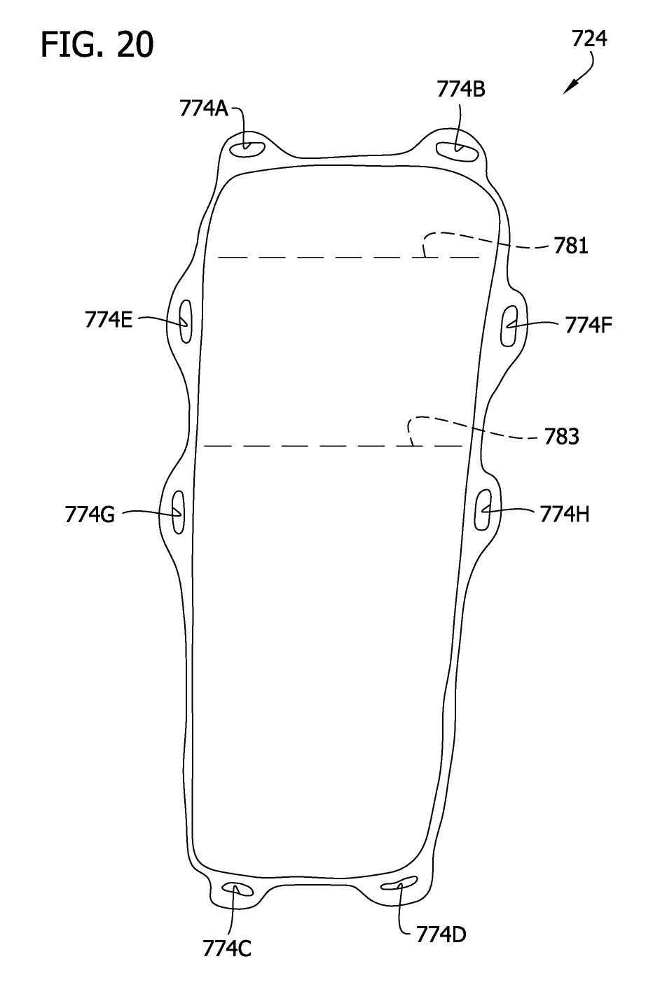

FIG. 20 illustrates another embodiment of a bladder 724. The bladder 724 may have a construction generally similar to the bladder 24 illustrated in FIG. 4. Corresponding parts are generally indicated by the same reference numbers, plus 700. In this embodiment, the bladder 724 has a body which is configurable so that it is capable of being re-sized for mounting on bladder supports having different sizes or on a single bladder support which has an adjustable size. More specifically, the bladder 724 is adapted to be folded for decreasing the length of the bladder. For example, the bladder 724 may be adjusted in length to generally conform to the length of a desired target compression zone on a body part of a person. Whether in an unfolded or folded state, the bladder connection structure is positioned for securely mounting the bladder 724 on the bladder support, i.e., for engaging the bladder support connection structure. In the illustrated embodiment, the bladder connection structure includes openings in the form of eyelets 774A-774H adapted for push-in reception with protrusions on a bladder support.

FIG. 20 illustrates the bladder 724 in an unfolded configuration in which the bladder has a “large” size including a relatively long length. The bladder includes eyelets 774A, 774B at the upper end of the bladder, eyelets 774C, 774D at the lower end of the bladder, openings 774E, 774F at an upper intermediate portion of the bladder, and eyelets 774G, 774H at a lower intermediate portion of the bladder. The bladder 724 has a first fold region (indicated by dotted line 781) between the eyelets 774A, 774B and 774C, 774D, where the bladder may be folded to decrease the size of the bladder to a “medium” size having a relatively medium length. The bladder 724 has a second fold region (indicated by dotted line 783) between the eyelets 774C, 774D and 774E, 774F, where the bladder may be folded to decrease the size of the bladder to a “small” size having a relatively small length. As will become apparent, when the bladder 724 is folded at the first or second fold regions 781, 783, the connection structure of the bladder remains in a position in which it is engageable with bladder support connection structure for mounting the bladder on a bladder support.

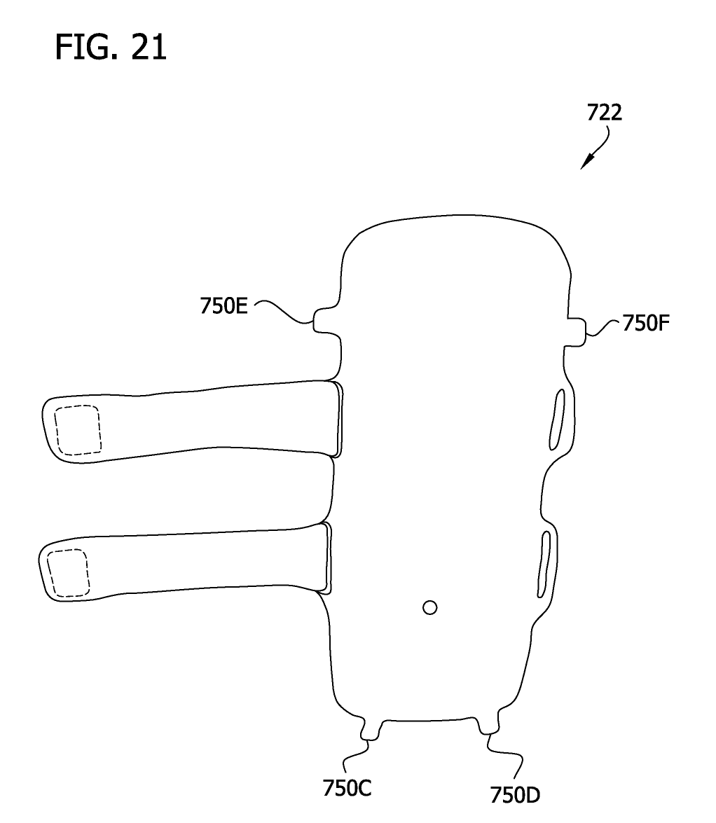

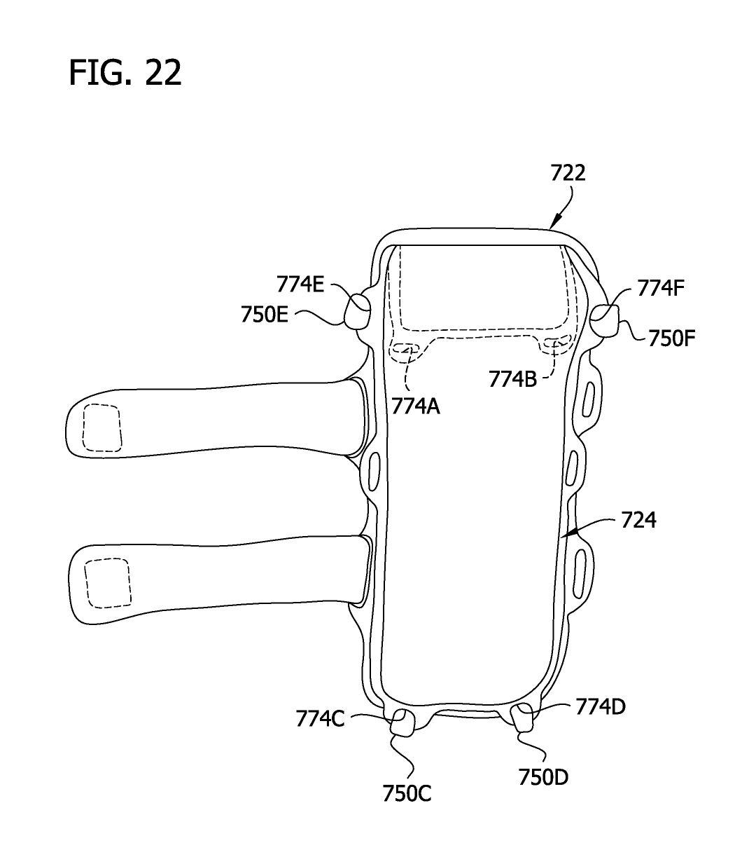

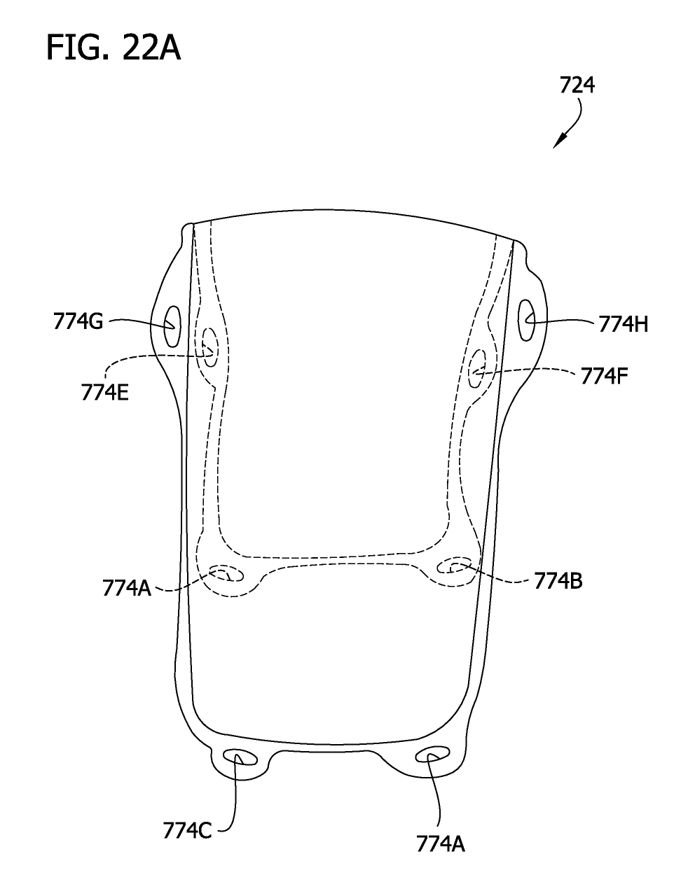

In the unfolded configuration, the bladder 724 may be mounted to a bladder support such as the bladder support 22 illustrated in FIG. 3. FIG. 21 illustrates another embodiment of a bladder support 722, which may be used with the bladder 724 when it is folded at the first fold region 781. The bladder support 722 may have a construction generally the same as embodiments described above. Corresponding parts are generally indicated by the same reference numbers, plus 700. In this embodiment, the bladder support 722 has connection structure including protrusions in the form of tabs 750C, 750D, 750E, 750F for mounting the bladder on the bladder support. The tabs 750E, 750F at the sides of the upper end of the bladder support 722 are positioned for push-in reception with the eyelets 774E, 774F. FIG. 22 illustrates the bladder 724 folded at the first fold region 781 and mounted on the bladder support 722 to form a “medium” sized compression assembly. As shown, the eyelets 774A, 774B, 774E, 774F are in a position to engage the tabs 750A, 750B, 750E, 750F.

FIG. 22A illustrates the bladder 724 in a second folded configuration. In this configuration, the bladder 724 is folded at the second fold region 783 to provide the bladder with a shorter length for forming a smaller compression assembly. Although the bladder 824 is not shown mounted on a bladder support in this position, it is understood various bladder supports may be used. For example, a shorter version of the bladder support 722 may be used, or an adjustable length bladder support may be used. In the second folded configuration, the eyelets 774G and 77411 are positioned for engaging connection structure such as tabs on a bladder support. Eyelets 774G and 774H may be positioned in registration with respective eyelets 774E and 774F when the bladder is mounted on a bladder support.

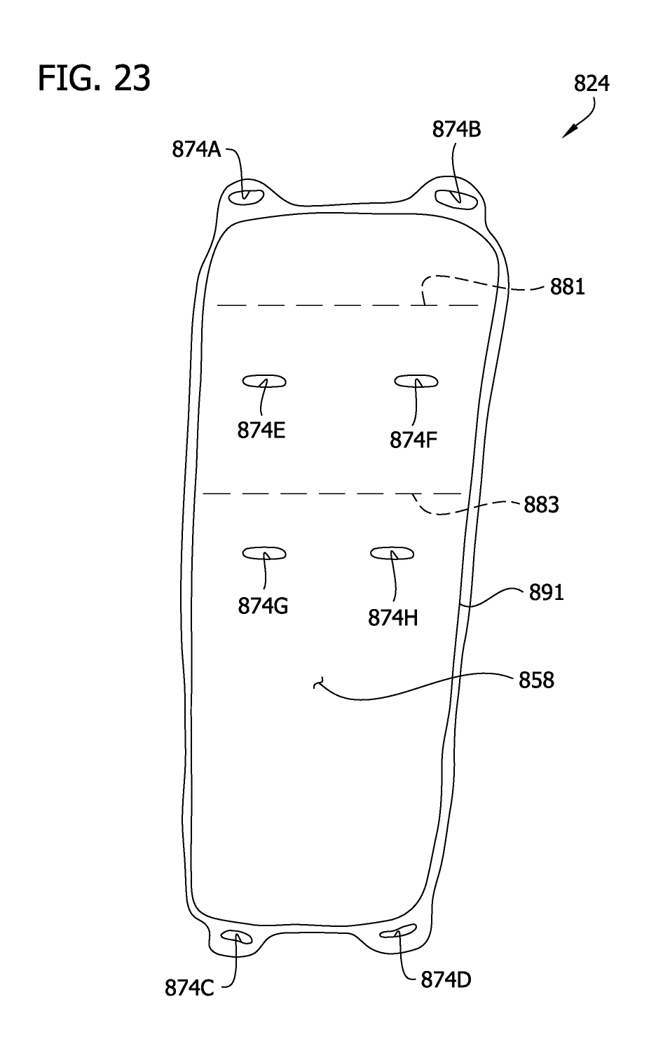

FIG. 23 illustrates another embodiment of a bladder 824. The bladder 824 may have a construction generally similar to the bladder 24 illustrated in FIG. 4. Corresponding parts are generally indicated by the same reference numbers, plus 800. Like the embodiment illustrated in FIG. 20, the bladder 824 has a body which is configurable so that it is capable of being re-sized for mounting on a bladder supports having different sizes or on a bladder support which has an adjustable size. More specifically, the bladder 824 is adapted to be folded for decreasing the length of the bladder. Whether in an unfolded or folded state, the bladder connection structure is positioned for securely mounting the bladder 824 on a bladder support, i.e., for engaging the support connection structure. In the illustrated embodiment, the bladder connection structure includes openings in the form of eyelets 874A-874H adapted for push-in reception with protrusions on a bladder support.

FIG. 23 illustrates the bladder 824 in an unfolded configuration in which the bladder has a “large” size including a relatively long length. The bladder 824 includes eyelets 874A, 874B at the upper end of the bladder, eyelets 874C, 874D at the lower end of the bladder, eyelets 874E, 874F at an upper intermediate portion of the bladder, and eyelets 874G, 874H at a lower intermediate portion of the bladder. The eyelets 874A-874D at the upper and lower ends of the bladder are provided outboard of the outer perimeter 891 of the inflatable chamber 858. The eyelets 874E-874H at the upper and lower intermediate portions of the bladder are provided inboard of the outer perimeter 891 of the inflatable chamber 858. The bladder 824 has a first fold region (indicated by dotted line 881) between the eyelets 874A, 874B and 874E, 874F, where the bladder may be folded to decrease the size of the bladder to a “medium” size having a relatively medium length. The bladder has a second fold region (indicated by dotted line 883) between the eyelets 874E, 874F and 874G, 874H, where the bladder may be folded to decrease the size of the bladder to a “small” size having a relatively small length. As will become apparent, when the bladder 824 is folded at the first and/or second fold regions 881, 883, the connection structure of the bladder is in a position in which it is engageable with a bladder support connection structure for mounting the bladder on the bladder support.

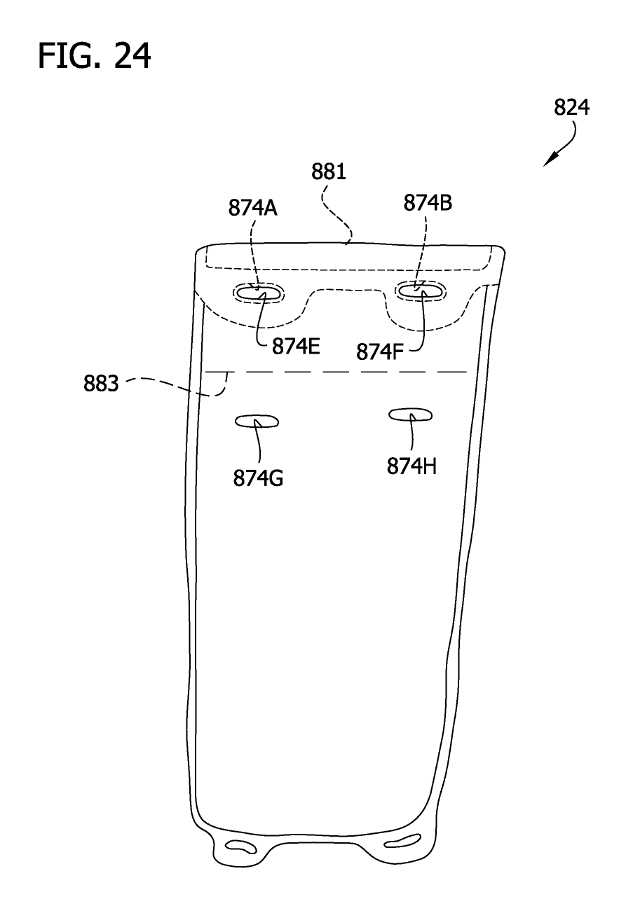

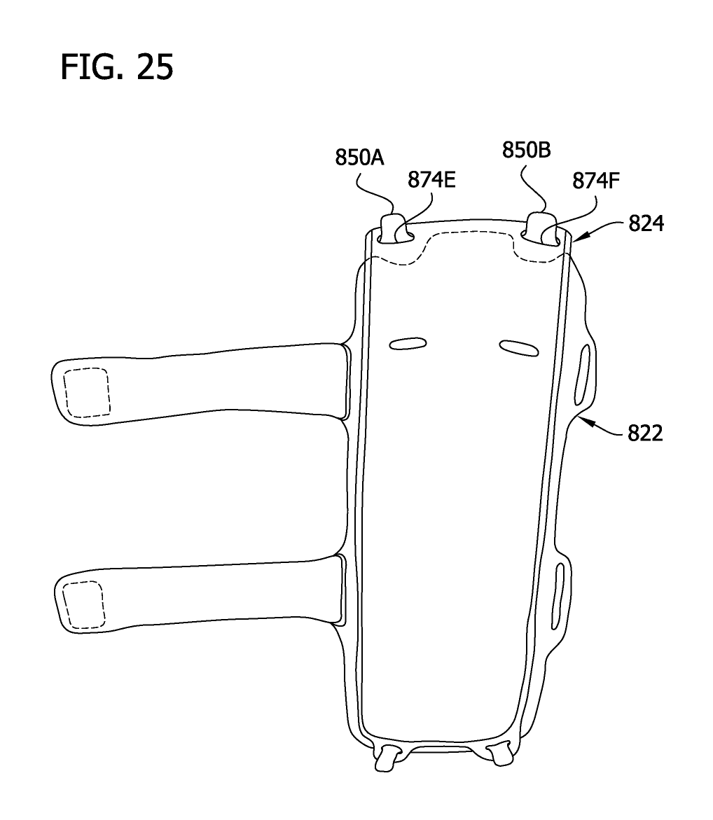

In the unfolded configuration, the bladder 824 may be mounted on a bladder support such as the bladder support 22 illustrated in FIG. 3, FIG. 24 illustrates the bladder 824 folded at the first fold region 881. In this configuration, the eyelets 874A, 874B and 874E, 874F are in registration with each other and are positioned for push-in reception with protrusions on a bladder support. FIG. 25 illustrates the bladder 824 in this configuration mounted on a bladder support 822, with the registered eyelets 874, 874B and 874E, 874F received on the tabs 850A, 850B. The bladder support 822 may be similar to the bladder support 22 (FIG. 3) or be adjustable in length like the bladder support 622 (FIG. 15). If the bladder support 822 is adjustable in length, it may be used for mounting the bladder in all of its unfolded and folded configurations.

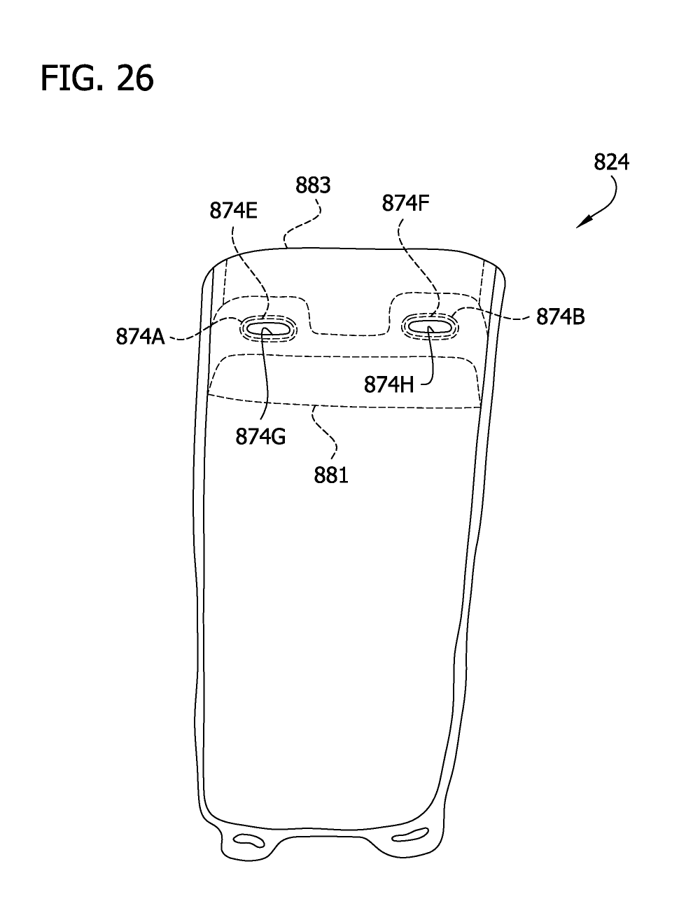

FIG. 26 illustrates the bladder 824 in a second folded configuration. In this configuration, the bladder 824 is folded at the first and second fold regions 881, 883 such that the eyelets 850A, 850B are in registration with the eyelets 850E, 850F and the eyelets 850G, 850H and positioned for push-in reception with protrusions on a bladder support. Although the bladder 824 is not shown mounted on a bladder support in this position, it is understood various bladder supports may be used, such as supports like those shown in FIGS. 3 and 15.

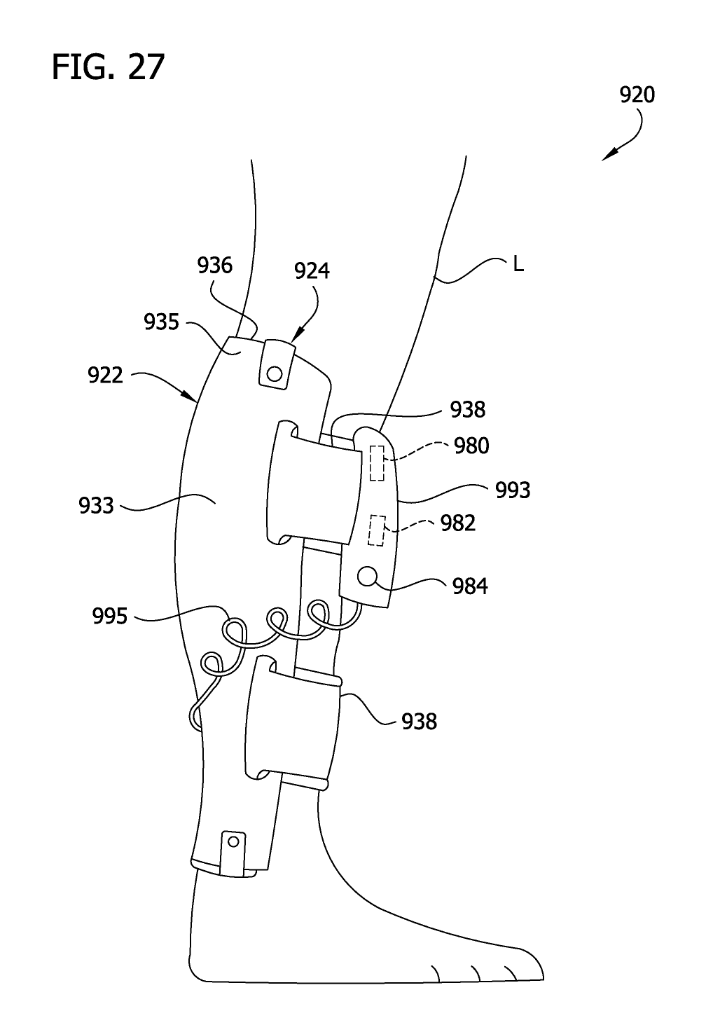

FIGS. 27-30 illustrate yet another embodiment of a compression assembly 920 according to the present invention. The compression assembly is generally similar to the compression assembly 20 described above, and corresponding parts are generally indicated by the same reference numbers, plus 900. For example, the compression assembly 920 includes a bladder support 922 and a bladder 924. FIG. 27 illustrates the compression assembly 920 secured in a self-retaining configuration or position around the leg L. Fastening assemblies 938 secure the compression assembly 920 on the leg L. A housing 993 including a controller 980, source of pressurized gas 982, and a power supply 984 is mounted on one of the fastening assemblies 938 for inflating the bladder 924 via a flexible conduit 995.

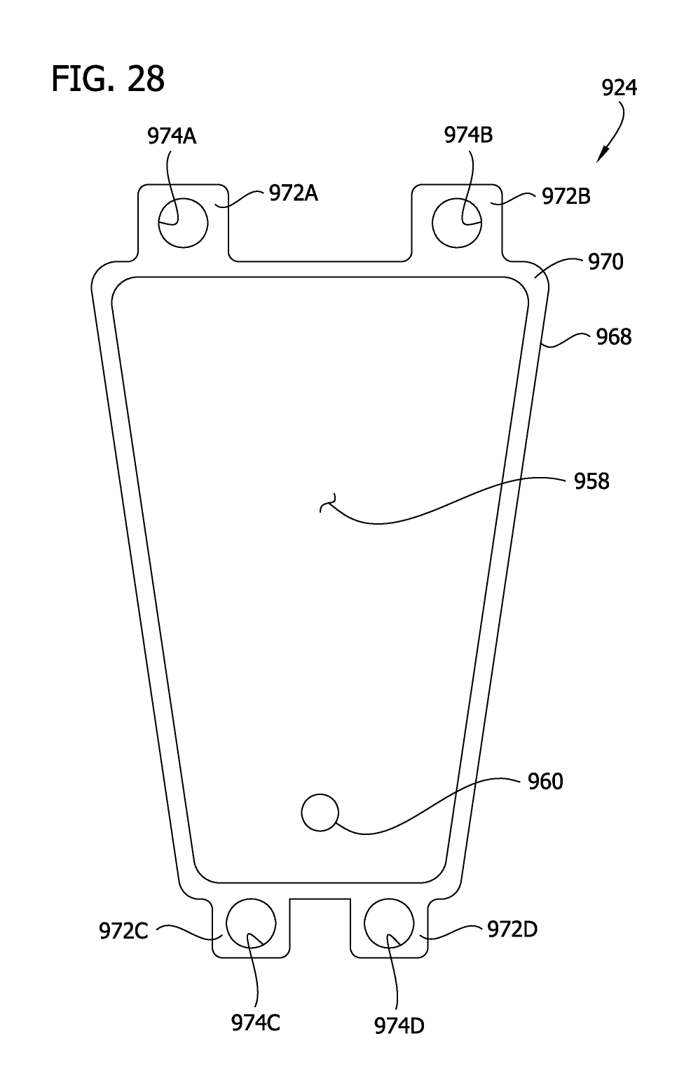

FIG. 28 illustrates a front elevation of the bladder 924. As with the bladders described above, the bladder 924 includes an inflatable chamber 958, a port 960 providing communication with the inflatable chamber, and bladder connection structure for mounting the bladder 924 on the bladder support 922. In the illustrated embodiment, the bladder connection structure includes openings in the form of eyelets 974A-974D. The eyelets 974A, 974B are provided at the upper end of the bladder 924, and the eyelets 974C, 974D are provided at the lower end of the bladder. The eyelets 974A-974D are spaced about the peripheral edge margin 970 of the bladder adjacent its peripheral edge 968. More specifically, the eyelets 974A-974D are provided on portions or flaps 972A-972D extending from the main body of the bladder. As explained in further detail below, the flaps 972A-972D are foldable for positioning the bladder connection structure for engagement with the bladder support connection structure.

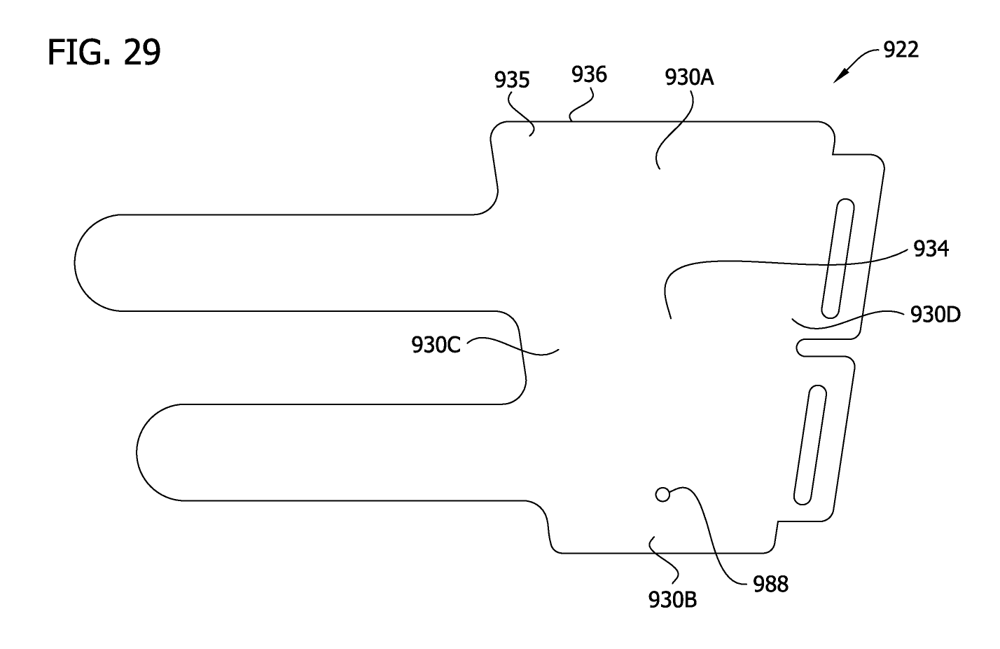

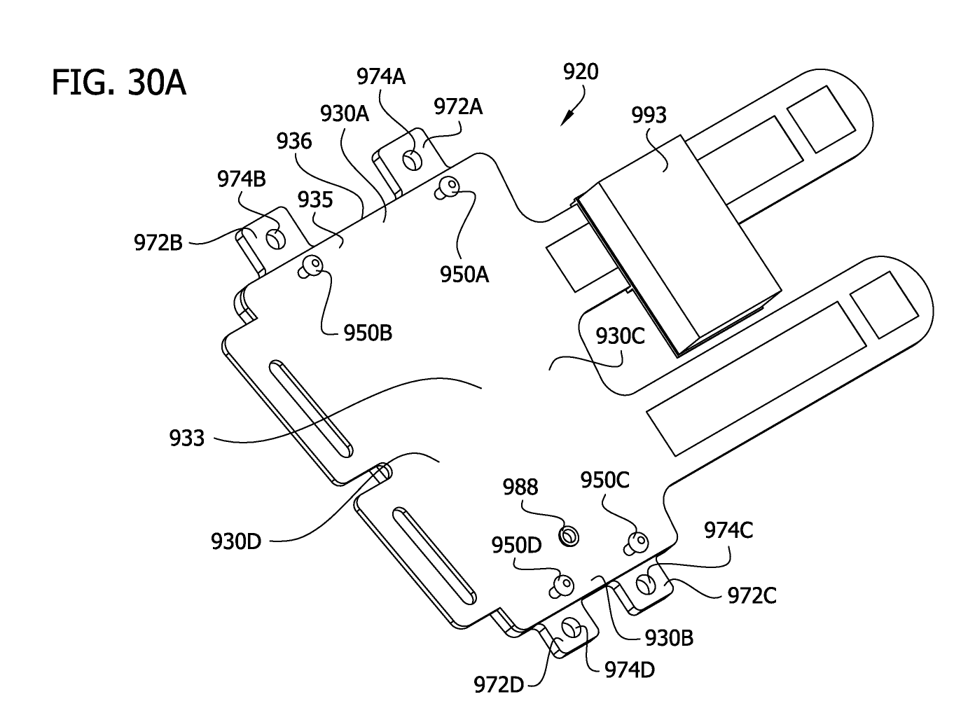

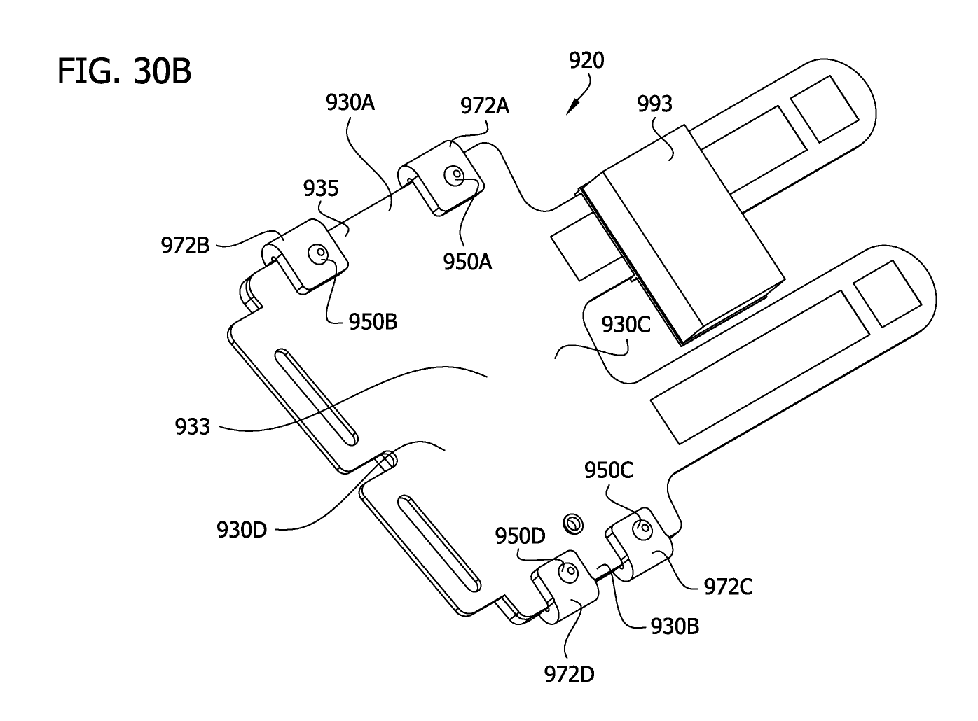

FIG. 29 illustrates a front elevation of the bladder support 922. As with embodiments described above, the bladder support 922 includes a support surface 934 and a rear surface 933 (FIG. 30A). The bladder support 922 also includes a port 988 through which the flexible conduit 995 may be connected with the port 960 on the bladder 934, like described above with respect to the embodiment shown in FIG. 7. As with the bladder supports described above, the bladder support 922 includes a peripheral edge margin 935 including a peripheral edge 936. The peripheral edge extends along the upper and lower ends 930A, 930B and the left and right sides 930C, 930D of the bladder support 922. The peripheral edge margin 935 extends on the support surface 934 and on the rear surface 933 (FIGS. 27 and 30) along the upper and lower ends 930A, 930B and the left and right sides 930C, 930D of the bladder support 922. In this embodiment, the support connection structure is provided in the form of protrusions 950A-950D spaced about the peripheral edge margin 935 on the rear surface 933 of the bladder support 922. More specifically, two protrusions 950A, 950B are provided at the upper end of the rear surface 933, and two protrusions 950C, 950D are provided at the lower end of the rear surface. As shown in FIG. 30B, to mount the bladder 924 on the bladder support 922, the flaps 972A-972D are folded over the peripheral edge 936 of the bladder support, and the eyelets 974A-974D are connected via push-in reception with the protrusions 950A-950D. The protrusions 950A-950D may be spaced for tensioning the bladder, as described above.

In the illustrated embodiment, the protrusions 950A-950D have a mushroom-like shape, similar to the protrusion 350B described above with respect to FIG. 9. The protrusions 950A-950D have rounded cone-shaped heads which have a diameter that is slightly larger than the eyelets 974A-974D on the bladder 924 such that the eyelets stretch, temporarily deforming the eyelets as they are received over the heads. The eyelets are retained on bases of the protrusions 950A-950D between the heads and the rear surface 933 of the support structure 922. It is understood other types of protrusions may be used without departing from the scope of the present invention. For example, prongs, hooks, or keys as described above, or other types of protrusions may be used.

It is also understood the bladder support 922 may be adjustable in length (e.g., may include a base and extension as described above) for use with bladders having different lengths or bladders which are adjustable in length.

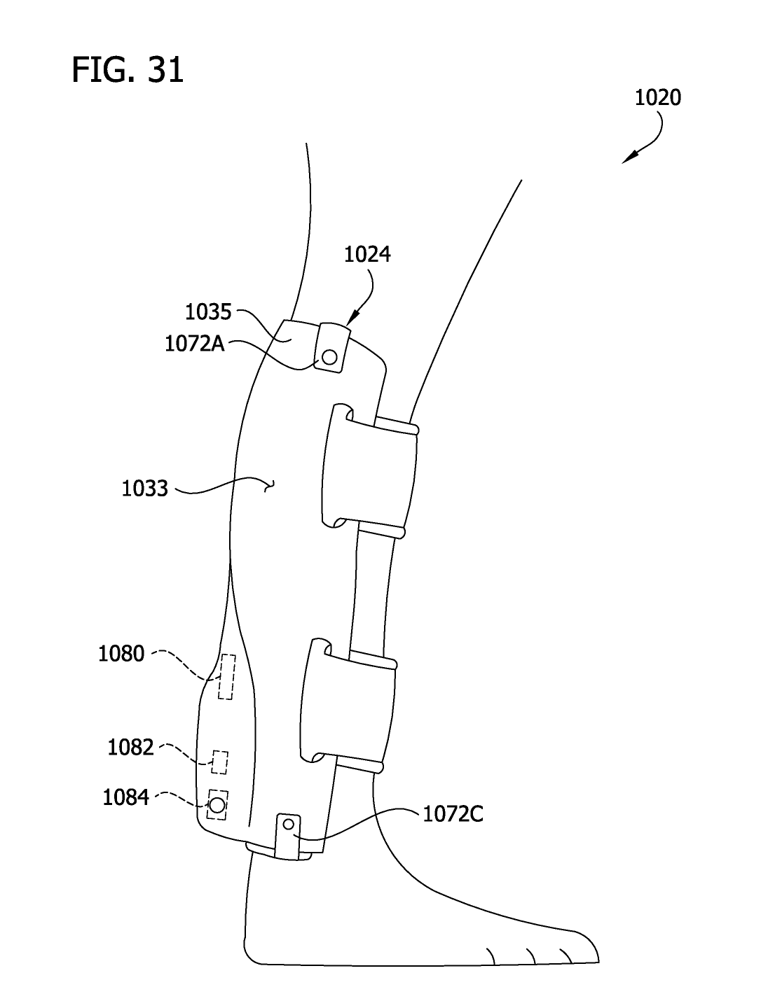

FIG. 31 illustrates yet another embodiment of a compression assembly 1020 according to the present invention. The compression assembly is generally similar to the compression assembly 20 described above, and corresponding parts are generally indicated by the same reference numbers, plus 1000. The compression is particularly similar to the assembly 920 in that it includes a bladder 1024 having foldable portions or flaps (only 1072A and 1072C being shown) for positioning the bladder connection structure for engagement with support connection structure on the rear surface 1033 of the bladder support 1022 spaced about the peripheral edge margin 1035. In this embodiment, the controller 1080, source of pressurized gas 1082, and a power supply 1084 are integrated with the bladder support, as described above with respect to the embodiment shown in FIG. 5.

The below statements are descriptions of other aspects of the inventions disclosed herein.D1. A compression assembly adapted for placement on a body part for imparting compression therapy on the body part, the compression assembly comprising: a bladder having a length and a width, front and rear surfaces, a peripheral edge margin, an inflatable chamber, and a port providing fluid communication with the inflatable chamber, the bladder having one of openings and rigid or semi-rigid protrusions located generally about the peripheral edge margin of the bladder; and a bladder support including a support surface and an opposite rear surface, the support surface being adapted for engaging the rear surface of the bladder, the bladder support having a length, a width, a peripheral edge margin including a peripheral edge, and a fastening assembly for securing the bladder support in a self-retaining configuration about the body part in which the bladder is disposed at least partially between the support surface and the body part, the bladder support having the other of the openings and the protrusions located generally about the peripheral edge margin of the bladder support; wherein the openings and protrusions are sized and shaped for releasable push-in reception of the protrusions in the openings, and reception of the protrusions in the openings releasably mounts the bladder on the bladder support.

D2. The compression assembly as set forth in claim D1 wherein the openings and protrusions are sized and arranged so that when the bladder is mounted on the bladder support the bladder is tensioned.

D3. The compression assembly as set forth in claim D1 wherein the openings are associated with the bladder and the protrusions are associated with the bladder support, at least one of the protrusions being located about the peripheral edge margin of the bladder support on the rear surface of the bladder support, and at least a portion of the bladder being foldable about the peripheral edge of the bladder support for positioning one of the openings for push-in reception with the protrusion.

D4. The compression assembly as set forth in claim D1 wherein the protrusions are associated with the bladder support and the openings are associated with the bladder, at least one of the protrusions extending outward from the peripheral edge of the bladder support.

D5. The compression assembly as set forth in claim D1 wherein the openings are associated with the bladder and the protrusions are associated with the bladder support, the peripheral edge margins including flaps extending outward from the bladder and at least one of the openings being located on the flaps.

D6. The compression assembly as set forth in claim D1 wherein said openings are keyholes.

D7. The compression assembly as set forth in claim D1 wherein the protrusions and openings are sized and shaped for deforming at least one of the bladder and the support surface upon reception of the protrusions in the openings for forming a releasable, interference fit of the protrusions in the opening.

D8. The compression assembly as set forth in claim D1 wherein the protrusions each include a head adapted for retaining the openings on the protrusions.

D9. The compression assembly as set forth in claim D1 further comprising a source of pressurized gas supported on and portable with the bladder support, and the bladder support includes a port adapted for connection to the source of pressurized gas and directly connected to the port of the bladder when the bladder is mounted on the support to establish direct fluid communication between the source of pressurized gas and the inflatable chamber.

D10. The compression assembly as set forth in claim D1 wherein the bladder support includes a port through which the port on the bladder is accessible for connection in fluid communication with a source of pressurized gas separate from the bladder support.

D11. The compression assembly as set forth in claim D1 wherein the bladder support includes a base and an extension, the base and the extension each defining at least a portion of the support surface, the extension being selectively movable with respect to the base for adjusting the size of the support surface.

D12. The compression assembly as set forth in claim D11 wherein the protrusions are associated with the bladder support and the openings are associated with the bladder, at least one of the protrusions being located on the base and at least one protrusion being located on the extension.

E1. A kit for forming first and second compression assemblies having different lengths and being adapted for placement on a body part for imparting compression therapy on the body part, the kit comprising: first and second bladders each having an inflatable chamber, a port providing fluid communication with the inflatable chamber permitting inflation of the inflatable chamber, and connection structure, the bladders each having a width and a length, the length of the first bladder being less than the length of the second bladder; and a bladder support having a fastening assembly for securing the bladder support in a self-retaining configuration on the body part, the bladder support having a support surface adapted for engaging the first and second bladders when the bladder support is in said self-retaining position, the bladder support including connection structure adapted for selectively engaging the connection structure of one of the first and second bladders for securely mounting the first and second bladders in a position for applying compression therapy to the body part, the bladder support including a base and an extension, the extension being selectively movable with respect to the base for adjusting a length of the support surface for conforming to the length of the first bladder for forming said first compression assembly with the first bladder, and the extension being selectively movable with respect to the base for adjusting the length of the support surface for conforming to the length of the second bladder for forming said second compression assembly with the second bladder, wherein the first compression assembly has a length which is shorter than a length of the second compression assembly,

E2. The kit as set forth in claim E1 wherein the support connection structure of the bladder support is provided on the base and the extension.

E3. The kit as set forth in claim E1 wherein the base and the extension each define at least a portion of the support surface.

F1. A configurable bladder capable of being re-sized for mounting the bladder on a selected bladder support for placement on a body part for imparting compression therapy on the body part, the bladder support having connection structure for mounting the bladder on the bladder support, the bladder comprising a body including walls defining an inflatable chamber, a port through one of the walls for providing fluid communication with the inflatable chamber permitting inflation of the inflatable chamber, the body having a first end, a second end opposite the first end, and a peripheral edge margin including a peripheral edge, the body including connection structure associated with at least one of the walls adapted for connecting to the connection structure of the bladder support for mounting the bladder on the bladder support, the body having a first configuration in which the connection structure of the body is positioned for engaging the connection structure of the bladder support for securely mounting the body on the bladder support, and the body having a second configuration in which the walls are folded to decrease the size of the body and the connection structure of the body is positioned for engaging the connection structure of the bladder support for securely mounting the body on the bladder support.

F2. The bladder as set forth in claim F1 wherein in the first configuration the walls are unfolded.

F3. The bladder as set forth in claim F1 wherein the body has a third configuration in which the walls are each folded at least two times to decrease the size of the body to a size smaller than the size of the body in the second configuration and, when in the third configuration, the connection structure of the body is positioned for engaging the connection structure of the bladder support for mounting the body on the bladder support.

Having described the invention in detail, it will be apparent that modifications and variations are possible without departing from the scope of the invention defined in the appended claims.

When introducing elements of the present invention or the preferred embodiments(s) thereof, the articles “a”, “an”, “the”, and “said” are intended to mean that there are one or more of the elements. The terms “comprising”, “including”, and “having” are intended to be inclusive and mean that there may be additional elements other than the listed elements.

In view of the above, it will be seen that the several objects of the invention are achieved and other advantageous results attained.

As various changes could be made in the above constructions and methods without departing from the scope of the invention, it is intended that all matter contained in the above description and shown in the accompanying drawings shall be interpreted as illustrative and not in a limiting sense.

What is claimed is:

1. A compression assembly adapted for placement on a body part for imparting compression therapy on the body part, the compression assembly comprising:
a bladder having a length and a width, front and rear surfaces, a peripheral edge margin, an inflatable chamber, and a port providing fluid communication with the inflatable chamber, the bladder having connection structure located generally about the peripheral edge margin of the bladder; and
a bladder support including a support surface and an opposite rear surface, the support surface being adapted for engaging the rear surface of the bladder, the bladder support having a length, a width, a peripheral edge margin including a peripheral edge, and a fastening assembly for securing the bladder support in a self-retaining configuration about the body part in which the bladder is disposed at least partially between the support surface and the body part, the bladder support being more rigid than the bladder, the bladder support having connection structure located generally about the peripheral edge margin of the bladder support for mounting the bladder on the bladder support, and the connection structure of the bladder support being adapted for releasable engagement with the connection structure of the bladder support, the connection structures of the bladder and bladder support being arranged so that the bladder is held in tension when mounted on the bladder support.

2. The compression assembly as set forth in claim 1 wherein at least a portion of the bladder is resiliently elastic.

3. The compression assembly as set forth in claim 1 wherein the bladder support is inelastic.

4. The compression assembly as set forth in claim 2 wherein the bladder support is semi-rigid.

5. The compression assembly as set forth in claim 1 wherein the bladder support is rigid.

6. The compression assembly as set forth in claim 1 wherein the connection structure of the bladder support includes connection structure positioned on said rear surface of the bladder support.

7. The compression assembly as set forth in claim 6 wherein the connection structure of the bladder includes flaps foldable over the peripheral edge of the bladder support for engaging the connection structure of the bladder with the connection structure of the bladder support.

8. The compression assembly as set forth in claim 1 wherein the bladder support includes a base and an extension, the base and the extension each defining at least a portion of the support surface, the extension being selectively movable with respect to the base for adjusting the size of the support surface.

9. The compression assembly as set forth in claim 8 wherein the connection structure of the bladder support is provided on the base and the extension.

10. A bladder for use with a bladder support in forming a compression assembly adapted for placement on a body part for imparting compression therapy on the body part, the bladder support including connection structure for mounting the bladder on the bladder support, the bladder comprising a body having a length and a width, front and rear surfaces, a peripheral edge margin, an inflatable chamber, and a port providing fluid communication with the inflatable chamber, the body having connection structure adapted for engaging the connection structure of the bladder support for positioning the bladder in a mounted position on the bladder support, at least a portion of the body being resiliently elastic which maintains the connection structure of the bladder in engagement with the connection structure of the bladder support when the bladder is in the mounted position on the bladder support.

11. The bladder of claim 10 further comprising front and rear walls defining the front and rear surfaces of the body and defining the inflatable chamber therebetween, the front and rear walls of the bladder being formed of resiliently elastic material.

12. The bladder of claim 11 wherein the connection structure of the bladder is located generally about the peripheral edge margin of the bladder.

13. The bladder of claim 10 wherein the connection structure is resiliently elastic.

14. A bladder support for use with a bladder for forming a compression assembly adapted for placement on a body part for imparting compression therapy on the body part, the bladder having a port providing fluid communication with an inflatable chamber on the bladder and having connection structure for mounting the bladder on the bladder support, the bladder support comprising:
a fastening assembly for securing the bladder support in a self-retaining configuration about the body part;
a body having a support surface and an opposite rear surface, the support surface being adapted for engaging the bladder when the bladder support is in said self-retaining position, and the body having a peripheral edge margin including a peripheral edge, the body having connection structure adapted for engaging the connection structure of the bladder for positioning the bladder in a mounted position on the bladder support, wherein the connection structure of the body is arranged for and the body has rigidity sufficient for tensioning the bladder when the bladder is in said mounted position on the bladder support.

15. The bladder support as set forth in claim 14 wherein the connection structure of the body includes protrusions spaced about the peripheral edge margin of the body which are adapted for releasable connection with the bladder.

16. The bladder support as set forth in claim 15 wherein at least one of the protrusions extends outward from the peripheral edge of the body.

17. The bladder support as set forth in claim 14 wherein the support structure of the body includes support structure positioned on the rear surface of the body.

18. The bladder support as set forth in claim 14 wherein the bladder support includes a source of pressurized gas supported on and portable with the bladder support, and the bladder support includes a port for forming a direct connection with said port on the bladder for establishing direct fluid communication between the source of pressurized gas and the inflatable chamber.

19. The bladder support as set forth in claim 14 wherein the body of the bladder support includes a base and an extension, the base and the extension each defining at least a portion of the support surface, the extension being selectively movable with respect to the base for adjusting the size of the support surface.
